(19) United States
(12) Patent Application Publication
(10) Pub. No.: US 2015/0278946 A1
(43) Pub. Date: Oct. 1, 2015

(54) Methods, Systems, Devices and Associated Computer Executable Code for Facilitating Securitized Funding of Deposits, Collateral, Bonds and/or Securities

(71) Applicant: PAY IT SIMPLE LTD., Jerusalem (IL)

(72) Inventors: Gil Don, Tel Aviv (IL); Alon Feit, Herzelia (IL); Victoria Niel Kraine, Herzelia (IL)

(21) Appl. No.: 14/686,987

(22) Filed: Apr. 15, 2015

Related U.S. Application Data
(63) Continuation-in-part of application No. 14/224,129, filed on Mar. 25, 2014.
Application No. 14/224,129 is a continuation of application No. 13/644,876, filed on Oct. 4, 2012, now Pat. No. 8,706,624.
Application No. 13/644,876 is a continuation-in-part of application No. 12/344,371, filed on Dec. 26, 2008, now Pat. No. 8,290,864.
(60) Provisional application No. 61/016,818, filed on Dec. 27, 2007.

(51) Int. Cl. G06Q 40/02

(52) U.S. Cl. CPC G06Q 40/025

(57) ABSTRACT

Disclosed are methods and systems for facilitating credit based transactions associated with purchase of goods, services or real estate having a cost, any other transaction and/or for providing a security, collateral, deposit or bond. According to some embodiments of the present invention, data indicating the cost of goods, service, security, collateral, deposit or bond may be received over a data network. The cost of the transaction/security may then be securitized over a data network against a credit line provided by a primary credit provider. Upon securitization, a secondary credit provider may fund the transaction/security. The secondary credit provider may intermittently receive partial payment of the transaction's cost while intermittently re-securitizing an outstanding transaction balance until the entire transaction cost+any associated fees/commissions has been repaid.

### PRIORITY CLAIMS

This application is a continuation in part of:

U.S. patent application Ser. No. 14/224,129, titled “Methods, System and Associated Computer Executable Code for Facilitating Credit Transactions”, filed by the inventors of the present invention on Mar. 25, 2014, which, in turn, is a continuation of:
U.S. patent application Ser. No. 13/644,876, titled “Methods, System and Associated Computer Executable Code for Facilitating Credit Transactions”, filed by the inventors of the present invention on Oct. 4, 2012, which, in turn, is a continuation in part of:
U.S. patent application Ser. No. 12/344,371, titled “Method and System for Facilitating Credit Transactions”, filed by the inventors of the present invention on Dec. 26, 2008, which, in turn, claims priority from:
U.S. Provisional Patent Application No. 61/016,818, titled “Method and System for Facilitating Credit Transactions”, filed by the inventors of the present invention on Dec. 27, 2007.
each of which the present application claims priority from and is hereby incorporated herein, by reference, in entirety.

### FIELD OF THE INVENTION

The present invention generally relates to the field of financial credit transactions. More specifically, the present invention relates to methods, systems, devices and associated computer executable code for facilitating credit transactions or securitizations.

### BACKGROUND OF THE INVENTION

People, inherently, in most of the western civilization, spend a significant portion of their life and money on the purchase of products and services. While fulfilling this purchasing “role”, they are identified as Consumers. The common, and logical, perception is that for a consumer to be able to purchase her/his desired goods or services, be it day to day needs, assets, presents, travel, etc., she/he is required to have the available financial means; namely “enough money in the bank”, or elsewhere.

Several consumption and purchasing mechanisms have been around, some going back to the dawn of history, allowing consumers to purchase goods and services without necessarily having the required funds at the time of purchase, rather using another's money to finance the purchase, and then repaying the money at a later stage.

To name a few current such financing schemes:
Bank loans;
Mortgages;
Leasing (cars, etc.); and
Revolving credit card schemes: allowing consumers to pay their credit card expenses gradually (revolving them).

Obviously these financing methods, and others, do not come free of charge. Consumers are usually charged, on top of the purchase cost, financing fees by the institute or body providing the funds that enable the purchase.

It is quite often that such financing mechanisms are used even by consumers having enough immediate funds, but preferring to not spend them on the current purchase, thus controlling their cash flows, just like any business firm does.

Possible reasons for such behavior may include:
A future expense is expected and will require available funds;
The current purchase, for which a “loan” is taken, is about to exceed the consumer's periodical budget/salary;
Money is invested and cannot be used; and
Emotional/Psychological motivations (e.g.: financial security).

The financing solutions are provided by a variety of sources, some providing a general purpose loan, not linked to a specific purchase, and others link the “loan” to a specific purchase/product/service. For example:

General purpose financing:
Credit card issuers (revolving credit accounts, etc.);
Financial institutions: banks, etc. (loans); and
Installment loans.
Specific financing:
Mortgage banks;
Car/other leasing companies; and
Merchants or service providers.

### Revolving Credit Card Loans

The revolving instrument is a common worldwide credit card industry solution of general purpose loans. In the revolving method, a cardholder can decide how much of his monthly credit card expenses he would rather revolve to the next month (within certain limitations).

The financing costs for such instrument are Annual Percent Rate (APR) derived from the national Federal interest rate. It is not fixed, and usually rises well above the Federal interest rate.

One reason for the high revolving APRs is the “risk” institutes (Credit card issuers/banks), providing such loans, take: A card holder can try avoiding some or all future payments, when in fact the product or service is already his/hers, in several ways:
Denying the purchase;
Closing the account; or
“Disappearing”.
   Such cases “expose” the loaning institute to unplanned cost and thus loss of money.

The revolving mechanism is common in the US consumer credit market, due to the popularity of credit cards as a monetary instrument (over 150 million cards in the year 2006), where more than 60% of cardholders are using revolving credit line on their cards.

Once a consumer has been approved for a credit line (usually pre approval), it is easy and immediate to use revolving mechanism for any purpose at any time, using his/her credit card. It is though, carrying one of the most expensive interest rates for consumers.

During 2006 the revolving system in the credit card industry at the US only had an outstanding of approximately US$826.6 Billion, compared to US$ 1,526.4 Billion in non-revolving credit system (e.g.—loans) for consumer spending (excluding housing), most of which is not done through credit cards.

Americans are used to using non-revolving credit (mainly leasing or other periodical pay-back loans) for high value items such as cars, mobile homes, education, boats or vacations. These are usually financed by the manufacturers or financial institutions in fix monthly installments.

### Leasing

Leasing loans are available in the US, but are mostly limited to specific high ticket purchases, such as cars, houses and boats, provided directly by the merchant and dedicated for the desired consumer product i.e. “specific purchase” loan.

In this case, the purchased product is registered as a guarantee for the given loan. The APRs for such loans vary between industries and are usually lower than the APR of the revolving′ credit card APR's. This kind of credit loan is usually not preapproved as in the case of revolving credit card accounts.

It is further noteworthy that modern life often requires, or makes it desirable, to deposit or otherwise convey a security, collateral or bond (hereinafter collectively referred to as “a security”) to another party in order to insure a contract, property or other interest.

### SUMMARY OF THE INVENTION

According to some embodiments of the present invention, as part of a transaction between a merchant, or first party, and a purchaser of goods, or services, or of financial services, or of real estate, of lease services, renter and/or a leaser of any goods, services and/or real estate etc. (herein after referred to as “Consumer” or “Customer”, this term should be understood herein to refer to any 2^{nd} party to a transaction), the Consumer may request to split a cost or payment, required from the Customer in connection with the transaction, into a set of partial repayments or installments such that the full transaction cost may be spread across the set of partial repayments, which partial repayments are spread across and made intermittently over some period of time. One or more credit providers may execute/provide full or partial payment for the transaction, to the merchant on behalf of the Consumer, on condition that the Consumer will repay the full transaction amount along with financing charges to the creditor using periodic partial repayments, wherein an outstanding repayment balance may substantially continuously be securitized by an intermittent re-securitization mechanism. According to further embodiments, the intermittent re-securitization mechanism described herein may be used to provide a security for a transaction, a service, a use of property, a loan or any other interest.

According to some embodiments, the one or more credit providers executing a transaction related payment on behalf of the Customer may be secondary credit providers, which secondary credit provider may securitize any outstanding repayment balance against credit provided by a primary credit provider (e.g. Credit Card Issuer, Credit Card Underwriter, Credit Union or Bank, etc.). “Securitizing” in this description may refer to sending a request for a credit/transaction authorization to a credit card company or other primary credit provider and receiving a credit/transaction authorization in from the credit card company or other primary credit provider. Any reference in this application to “securitizing” an amount of funds should be understood to also refer to such processes.

An agreed upon schedule for the set of partial repayments amounts across an agreed period of time may be referred to as a repayment schedule and may be pre-defined or pre-determined. According to further embodiments, the repayment schedule (e.g. recurring repayment date, period between partial repayments, repayment amount, etc.) may be selected by the Consumer, for example during the transaction or purchase. According to even further embodiments, the repayment schedule may be altered or restructured (e.g. delayed repayments—extend period between repayments, accelerated repayments—reduce period between repayments, repayment date offset—change date of the month, repayment amount, etc.) after the transaction or purchase date. Re-securitization may be performed automatically in connection with the repayment schedule, i.e. may be re-scheduled based on the restructuring.

The present invention includes methods, systems, devices and associated computer executable code for facilitating credit transactions or securitizations. According to some embodiments of the present invention, as part of a transaction between a merchant, or first party, and a Consumer/Customer of goods and/or services and/or monetary means (e.g. cash), which may be initiated at or through any point of access (e.g. online, point of sale, mobile point of sale, automatic teller machine; and/or any communication device, such as a mobile phone, or attachment thereof, and or any other point of access known today or to be devised in the future), the Consumer may request to split the transaction cost into a set of payments/installments, by which costs may be spread over a period of time. Said set of payments and said period of time may be pre-defined or pre-determined.

According to some embodiments of the present invention, as part of a cost spread to installments, a Consumer of goods and/or services and/or monetary means (e.g. cash), may request that a secondary credit provider pay the merchant, or first party, the cost of the purchased goods and/or services. Said secondary credit provider may be any third party willing to finance said transaction (e.g. any financial institution, the merchant, or first party, himself). According to further embodiments, there may be a party which organizes payment by installments using the transaction system described hereinafter (e.g. an independent third party, a merchant, a secondary credit provider, a primary credit provider).

According to some embodiments of the present invention, the secondary credit provider may provide the Consumer with repayment terms (e.g. monthly payments/installments) for the principle amount to be paid by the secondary provider and/or for financing fees (e.g. interest or any other kind of fees). The secondary credit provider may securitize the amounts to be paid to the merchant against a credit line provided to the Consumer by a primary credit provider (e.g. credit card company). Concurrent with or prior to payment to merchant, or first party, the financing party (e.g. secondary credit provider) may request from the primary credit provider credit authorization for the remaining amounts due, including financing fees (e.g. interest, commission, any other supplementary fee(s) and possible penalties).

According to further embodiments, the following types of monetary costs/fees/transactions may be securitized: actual costs of transactions; financial fees (e.g. as stated above); any additional fees, fines and/or penalties associated with secondary credit; payments for damages caused to goods, real estate and so on; payment of fees, fines and/or penalties associated with the underlying transaction; payment of taxes, insurance(s) and/or any other payment associated with the underlying transaction; payment(s) of fees and penalties associated with the organizing of the secondary credit, with organizing payment by installments, with organizing the use of the transaction system described hereinafter, and so on.

According to yet further embodiments, the various costs, fees, penalties and/or damages may be distributed to partial payments (installments) according to various algorithms, including, but in no way limited to, the following cases: (i) each installment is of an equal amount; (ii) entire amount of several fees, or all fees, are included in the first installment; (iii) distribution of all above mentioned costs by virtually the same algorithm, in a manner substantially similar to the distribution of the interest in many real-estate loans; (iv) the cost, damages, fees and penalties associated with terminating/finishing/ending of the lease becomes a part of additional installment(s); (v) the cost, damages, fees and penalties associated with the premature termination of a transaction is added the current installment or the additional installment(s); (vi) the cost, damages, fees and penalties are added to the securitized amount based on algorithms that take into account probabilities and consumer profile, and other related considerations.

According to some embodiments of the present invention, the secondary credit provider may request from the primary credit provider partial payment of the authorized credit based on the agreed upon repayment terms between the secondary credit provider and the Consumer. Since each credit authorization expires either within a predefined period of time or based on some action, the secondary credit provider may re-securitize any remaining balance owed to it by the Consumer by intermittently re-requesting credit authorization for the remaining balance. Credit authorization may be performed prior to the previous authorization expiring, such as to eliminate any period of time the funds are not securitized.

According to some embodiments of the present invention, the above re-securitization and money transfer cycle may be re-executed until all due payments are transferred to the secondary credit provider. In the event of a re-securitization failure, said secondary credit provider may request the primary credit provider to transfer the full remaining balance from the Consumer to it, based on the last prior credit securitization performed.

According to further embodiments, the above described securitization and re-securitization systems and methods may be used to provide a consumer/customer/user with a deposit/collateral/Bond/security for a third party. The amount of the deposit/collateral/Bond/security, including financing fees (e.g. interest, commission, any other supplementary fee(s)) and possible penalties may be securitized against a credit line provided to the Consumer by a primary credit provider (e.g. credit card company). Concurrent with or prior to issuing the deposit/collateral/Bond/security the financing party (e.g. secondary credit provider) may request from the primary credit provider credit authorization for the amount of the deposit/collateral/Bond/security.

Since each credit authorization expires either within a predefined period of time or based on some action, the secondary credit provider may re-securitize any remaining balance of the security by intermittently re-requesting credit authorization for the remaining balance. Credit authorization may be performed prior to the previous authorization expiring, such as to eliminate any period of time the funds are not securitized.

According to some embodiments of the present invention, the financing party (e.g. secondary credit provider) may request from the primary credit provider or the consumer/customer/user partial payment of the issued security based on the agreed upon repayment terms between the secondary credit provider and the consumer/customer/user. The security may also be maintained without intermittent repayment, such that the original amount is continuously re-securitized prior to the expiration of the previous authorization until the security is returned.

In the event of a re-securitization failure, said secondary credit provider may request the primary credit provider to transfer the full remaining balance from the Consumer to it, based on the last prior credit authorization performed.

According to some embodiments of the present invention, there may be provided methods and systems for facilitating credit based transactions associated with purchase of goods, services or real estate having a cost, any other transaction and/or providing a security. According to some embodiments of the present invention, data indicating the cost of goods, service or security may be received over a data network. The cost of the transaction/security may then be securitized over a data network against a credit line provided by a primary credit provider. Upon securitization, a secondary credit provider may fund the transaction/security. The secondary credit provider may intermittently receive partial payment of the transaction's cost and while intermittently re-securitizing an outstanding transaction balance.

According to some embodiments of the present invention, a transaction system may comprise of one or more transaction servers including a collective control logic adapted to: (1) receive over a data network the data indicating the cost of goods, service or security; (2) securitize over a data network the cost of the transaction/security against a credit line provided by a primary credit provider; (3) fund the transaction/security upon securitization; (4) intermittently receive partial payment from the primary credit provider; and (5) intermittently re-securitize an outstanding balance.

According to some embodiments, a transaction between a merchant, or a first party, and a consumer/Customer may involve the merchant, or first party, providing to the consumer/Customer goods, services, real estate, leasing services, financial services, any other service or product and/or any combination thereof. The transaction may be a conventional merchant transaction, an online transaction, a mobile transaction and/or any other type of transaction known today to be devised in the future.

According to some embodiments, the merchant, or first party, may be a retailer of goods and/or a provider of services such as: (1) financial services, (2) banking services, (3) leasing services, (4) communication services, (5) medical services, (6) travel services, (7) currency exchange service, or any other goods or services. The merchant may provide Customer with goods, services, cash or real estate: (1) at a manned point of sale (e.g. cash register), (2) through an automated apparatus (e.g. product dispenser, automatic teller machine, etc.), (3) through an online e-commerce site or through an online checkout application, and/or (4) via a mobile commerce system.

According to further embodiments the merchant or first party described herein may be a private individual or individuals, or an organization acting as a private individual(s), i.e. the systems and methods described herein may be implemented to provide installment and/or security services to business interactions between individuals (i.e. private parties).

According to yet further embodiments, the transaction or security between the two individuals, may be associated with an organized marketplace, which may be an online marketplace (e.g. Ebay™, Craigslist™) and the funding/payment/security methods and systems described above may be offered/facilitated through, or in conjunction/association with, the organized marketplace. According to further embodiments, the funding/payment/security methods and systems described above may be offered/facilitated by a separate application, device or system, possibly designed to interface with organized online marketplaces, to differing degrees. According to yet further embodiments the funding/paynnent/-security methods and systems described above may be offered/facilitated as stand-alone services, with and/or without subscription/registered service. According to some embodiments a Customer/consumer may establish facilities or availability for transaction/security payment by the secondary creditor (secondary credit provider) either during or in advance of a given transaction and/or security. As part of establishing a Payer arrangement with a secondary creditor, the Customer may provide personal and financial information including: (1) name, (2) address, (3) an identification number (e.g. Social Security Number), and (4) one or more identifiers of primary creditor accounts (e.g. credit card accounts) against which the secondary creditor may secure repayment of payments made or other consideration extended by secondary creditor on behalf of the Customer.

According to some embodiments of the present invention, as part of a transaction/security cost/amount being spread to installments, a Consumer of goods and/or services and/or monetary means (e.g. cash), may utilize a payment mechanism or token, such as a payment card or online payment application, provided by a secondary credit provider. Using the secondary credit provider's payment mechanism may cause the secondary credit provider to: (1) authenticate details of the transaction; (2) check availability of one or more primary credit-lines sufficient to cover the transaction amount, and (3) subject to (1) and (2), to pay the merchant some or all of the cost of the purchased goods and/or services. The secondary credit provider may be any third party willing to finance said transaction (e.g. pay the merchant).

According to some embodiments of the present invention, partial payment of the transaction's cost may be received either from the primary credit provider, directly from a purchaser of the goods or service, or from any other individual(s) and/or entity(ies) on behalf of such purchaser. Furthermore, the cost of such a transaction may be received by any of the abovementioned means or a combination thereof. According to some embodiments of the present invention, upon a re-securitizing failure, a secondary credit provider may receive full balance payment from the primary credit provider or receive re-securitization from the same primary credit provider or from other credit provider(s) using different account(s) of the Consumer or account(s) of other individual(s) or entities (upon prior or present instruction of consumer and prior or present consent of such individual(s) and entities).

According to further embodiments, partial payment (installments) may be received from the purchaser using direct transfer from the bank account or any other account of the purchaser; by using a check(s), or drafts, drawn against the purchaser's bank account or any other account, possibly as a ‘bank check’—a check drawn against assets and/or general credit of the bank; by any debit card; by any credit card; by any financial instrument; by cash; by wire transfer; by token(s); by electronic payment(s) (including over the Internet); by electronic payment of tokens (e.g. ‘web money’); and/or by any other method(s) known today or to be devised in the future. Any account, any debit card, any credit card and so on, does not necessary mean a purchaser's account or debit/credit card, but may refer to any account, debit/credit card and the like, of any other individual(s) or entity(ies).

According to further embodiments, revolving credit with securitization may be used for payment of leasing (rent), payment for goods and/or services, or payment for real estate. Furthermore, such methods may be used for securitization of periodic payments (e.g. timed installments such as monthly payments); payments for damages to leased property or any other damages; payment of various fines, fees and penalties related to the credit; payment of various fines, fees and penalties related to the underlying transaction, including various fees, fines, and penalties related to the termination or finishing of the lease; and/or costs of taxes, insurances, communal payments and so on, related to the underlying transaction. According to some embodiments, the revolving credit with securitization may allow the purchaser to avoid: bank guaranties, pre-payment for security deposit, cleaning fee, pre-payment for several rent periods/months, deposit for key, pre-payments for possible damages, and/or pre-payments for insurance, taxes and/or communal payments and any other pre-payment(s).

According to further embodiments of the present invention, the methods, systems and components for securing finance of costs by continuously securitizing and re-securitizing the costs against a credit line held with a primary credit provider, may also be used to:
a. provide merchants or other parties owed a debt in installments with a net present value of the debts (minus fees/commissions) in exchange for an assignment of the installments, provided the installments can be secured with a primary credit provider; and
b. provide funding of up-front payments, in scenarios in which there is an incentive or discount in exchange for up-front payment of a cost (e.g. a utility payment, country club membership, software license, etc.), provided the up-front payment can be secured with a primary credit provider.

### BRIEF DESCRIPTION OF THE EXEMPLARY FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying exemplary figures in which:

FIG. 1 is a flow chart describing the stages and steps of an exemplary method for facilitating installment transactions, in accordance with some embodiments of the present invention;

FIG. 2 is a table describing the modules of an exemplary system for facilitating transactions, in accordance with some embodiments of the present invention;

FIG. 3 is an image of an exemplary transaction payment arrangement, in accordance with some embodiments of the present invention;

FIG. 4 is a table describing the modules of an exemplary system for facilitating transactions comprising a consumer interface module, a merchant interface module and a primary credit provider(s) interface module, in accordance with some embodiments of the present invention;

FIGS. 5-12 are various exemplary primary credit provider securitization scenarios made by an exemplary system for facilitating transactions, in accordance with some embodiments of the present invention;

FIG. 13 is a flowchart presenting steps of exemplary methods for providing installment and/or security services by a secondary credit provider, in accordance with some embodiments of the present invention;

FIG. 14 is a flowchart presenting steps of exemplary methods for providing rent securitization services by a secondary credit provider, in accordance with some embodiments of the present invention;

FIG. 15 is a flowchart presenting steps of exemplary methods for providing installment and/or security services for a transaction between two private individuals, by a secondary credit provider, all in accordance with some embodiments of the present invention;

FIG. 16 is a flowchart presenting steps of exemplary methods for providing realization of installment purchases to merchants, by a secondary credit provider, all in accordance with some embodiments of the present invention;

FIG. 17 is a block diagram presenting the architecture of systems for providing installment and/or security services for a transaction between two private individuals, by a secondary credit provider, wherein the transaction and installment and/or security services are facilitated through an online market place, all in accordance with some embodiments of the present invention;

FIG. 18 is a block diagram presenting the architecture of systems for providing installment and/or security services for a transaction between two private individuals, by a secondary credit provider, wherein the buyer arranges the installment and/or security services with the secondary credit provider, all in accordance with some embodiments of the present invention;

FIG. 19 is a block diagram presenting the architecture of systems for providing installment and/or security services for a transaction between two private individuals, by a secondary credit provider, wherein the seller arranges the installment and/or security services with the secondary credit provider, all in accordance with some embodiments of the present invention;

FIG. 20 is a diagram presenting an example of a normal purchase transaction including installment services from a secondary credit provider, in accordance with a particular exemplary commercial embodiment of the present invention;

FIG. 21 is a diagram presenting an example of a chargeback process in a scenario involving a secondary credit provider, in accordance with a particular exemplary commercial embodiment of the present invention;

FIG. 22 is a diagram presenting an example of a collateral model involving a secondary credit provider, in accordance with a particular exemplary commercial embodiment of the present invention;

FIG. 23 is a diagram presenting an example of a P2P model involving a secondary credit provider, in accordance with a particular exemplary commercial embodiment of the present invention;

FIG. 24 is a diagram presenting an example of a secondary credit provider providing services to many different parties, in accordance with a particular exemplary commercial embodiment of the present invention;

FIG. 25 is a flowchart presenting steps of exemplary methods for providing up-front payment services, by a secondary credit provider, all in accordance with some embodiments of the present invention;

FIG. 26 is a flowchart presenting steps of exemplary methods for providing deposit/security services by a secondary credit provider for a service which requires a deposit/security from some or all of its customers in order to receive service and/or related equipment, in accordance with some embodiments of the present invention.

It should be understood that the accompanying drawings are presented solely to elucidate the following detailed description, are therefore, exemplary in nature and do not include all the possible permutations of the present invention. Further, it will be appreciated that for simplicity and clarity of illustration, elements shown in the figures have not necessarily been drawn to scale. For example, the dimensions of some of the elements may be exaggerated relative to other elements for clarity.

### DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, or a man operated such system, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

Furthermore, the Primary Credit Provider—may also be referred to as, or refer to, a credit card issuer (backed up by the card holder's credit/bank/other account) or any other supplier of a credit line; the Secondary credit provider—may, according to some embodiments, also be referred to as, or refer to, the Invention, the invention system or simply as the System. This however, shall not limit the present invention's embodiments, functions or abilities—to those of the Secondary credit provider as described in the present application; the Term Credit securitization—may comprise of some or all of the following steps, referred to as a Credit request, Credit authorization and Credit clearing that each may be accompanied/characterized by a corresponding time period (i.e. authorization expiration) and amount (i.e. authorization amount); The Consumer—may also be referred to as, or refer to, a Buyer, a Customer, a Credit Card holder or simply as the Card holder; and a partial payment (based on the repayment terms between the secondary credit provider and the Consumer)—may also be referred to as, or refer to, an Installment, intermittent payment, partial payment or intermittent partial payment.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention includes methods, systems, devices and associated computer executable code for facilitating credit transactions or securitizations. According to some embodiments of the present invention, as part of a transaction between a merchant, or first party, and a Consumer/Customer of goods and/or services and/or monetary means (e.g. cash), which may be initiated at or through any point of access (e.g. online, point of sale, mobile point of sale, automatic teller machine; and/or any communication device, such as a mobile phone, or attachment thereof, and or any other point of access known today or to be devised in the future), the Consumer may request to split the transaction cost into a set of payments/installments, by which costs may be spread over a period of time. Said set of payments and said period of time may be pre-defined or pre-determined.

According to some embodiments, a transaction between a merchant, or other first party, and a Customer/Consumer may involve the merchant, or other first party, providing to the Customer/consumer goods, services, financial services, the use of property or equipment and/or any combination thereof. The transaction may be a conventional merchant/sale transaction, an online transaction, a mobile transaction and/or any other type of transaction known today to be devised in the future. According to some embodiments, the merchant, or other first party may provide the Customer with negotiable financial instruments such as a currency of one or more countries, bearer bonds, or the like. All existing or future types of transactions possible between a merchant, or other first party, and a Consumer of goods and/or services may be supported (e.g. online/internet; point of sale; automatic teller machine, etc.) by various embodiments of the present invention.

According to some embodiments of the present invention, there may be provided methods and systems for facilitating credit based transactions associated with purchase of goods, services or real estate having a cost, any other transaction and/or providing a security. According to some embodiments of the present invention, data indicating the cost of goods, service or security may be received over a data network. The cost of the transaction/security may then be securitized over a data network against a credit line provided by a primary credit provider. Upon securitization, a secondary credit provider may fund the transaction/security. The secondary credit provider may intermittently receive partial payment of the transaction's cost while intermittently re-securitizing an outstanding transaction balance until the entire transaction cost+any associated fees/commissions has been repaid.

According to some embodiments of the present invention, a transaction system may comprise of one or more transaction servers including a collective control logic adapted to: (1) receive over a data network the data indicating the cost of goods, service or security; (2) securitize over a data network the cost of the transaction/security against a credit line provided by a primary credit provider; (3) fund the transaction/security upon securitization; (4) intermittently receive partial payment from the primary credit provider; and (5) intermittently re-securitize an outstanding balance.

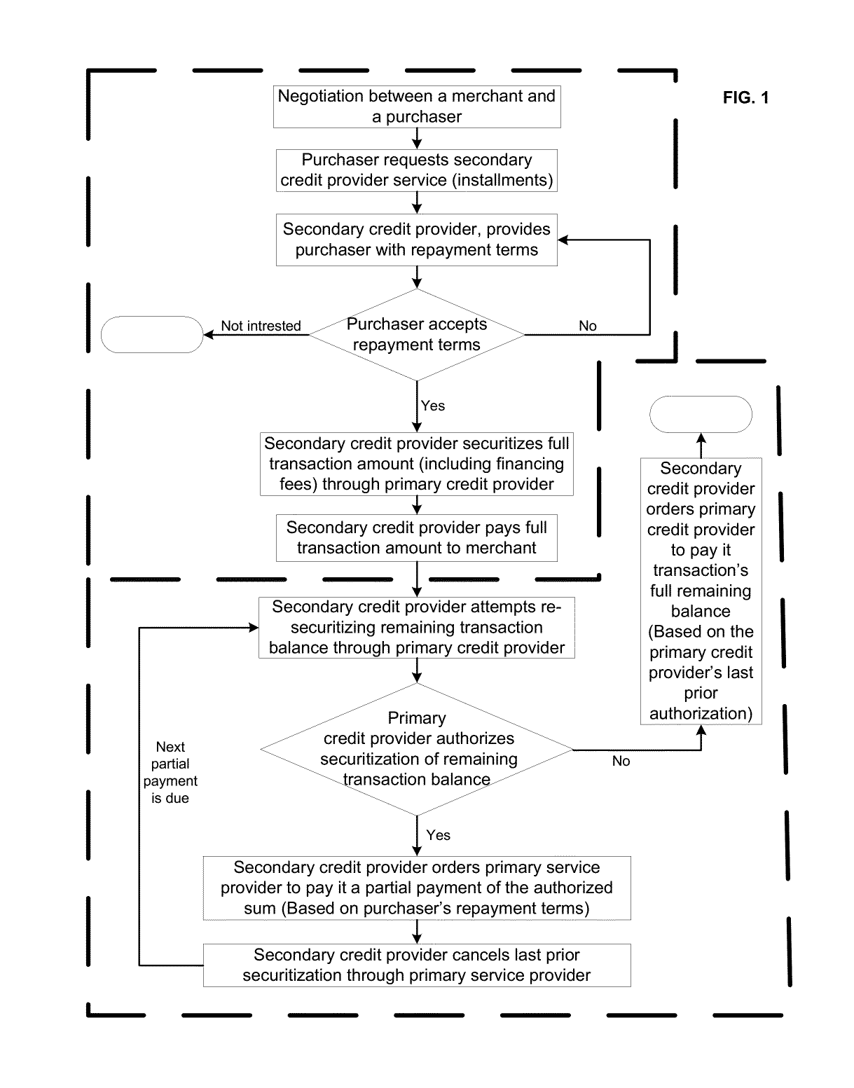

In FIG. 1 there is shown, in accordance with some embodiments of the present invention, a flow chart describing the stages and steps of an exemplary method for facilitating installment transactions. The first part of the process begins with a negotiation of the cost of goods or service between a merchant, or a first party, and a purchaser/consumer. Once the price has been agreed, the purchaser/consumer may request secondary credit provider services (installments), and may receive in return, possibly through the merchant or merchant terminal, the repayment terms offered by the secondary credit provider. The purchaser/consumer may then: accept the terms, request another repayment offer, or decide he is not interested. The Secondary credit provider then securitizes the full transaction amount (including financing fees) through the primary credit provider and pays the full transaction amount to the merchant, or first party. In the second part of the process, after one or more partial payments, the secondary credit provider attempts re-securitizing the remaining transaction balance through the primary credit provider. If the primary credit provider authorizes the securitization of the remaining transaction balance, the secondary credit provider orders the primary service provider to pay it a partial payment of the authorized sum (Based on purchaser's repayment terms) and cancels the last prior securitization made through the primary service provider, this iteration may repeat until the full amount of the transaction is paid to the secondary credit provider. If, on the other hand, the primary credit provider does not authorize the securitization of the remaining transaction balance, the secondary credit provider orders the primary service provider to pay it the transaction's full remaining balance (Based on the primary credit provider's last prior authorization).

According to some embodiments of the present invention, a securitization module may be adapted to receive over a data network the data indicating the cost of goods, security or service. The data may be received from a merchant agent selected from a group consisting of Terminal Merchant Agent, On-Line Merchant Agent, Check-out Provider Agent and Cash Withdrawal Agent. The securitization module may be further adapted to receive data relating to the number and/or sum(s) of said partial payments. According to some embodiments of the present invention, the securitization module may be adapted to securitize the cost of the transaction against a credit line provided by a primary credit provider, a securitization may comprise of initiating a credit request and receiving a credit authorization.

According to some embodiments of the present invention, a funds transfer module may be adapted to fund the transaction/security upon its securitization (e.g. by transferring funds to a merchant, or first party, supplying the goods/services). According to some embodiments of the present invention, a fund receipt module may be adapted to intermittently receive partial payment or to receive full payment, from the primary credit provider. The fund receipt module may be further adapted to receive full balance payment from the primary credit provider upon a re-securitization failure. According to some embodiments of the present invention, the transfer of funds to the merchant may only be done upon shipping of the goods to the consumer.

According to further embodiments, the securitization and re-securitization systems and methods described herein may be used to provide a consumer/customer/user with a deposit/collateral/Bond/security for a third party. The amount of the deposit/collateral/Bond/security, including financing fees (e.g. interest, commission, any other supplementary fee(s)) and possible penalties may be securitized against a credit line provided to the Consumer by a primary credit provider (e.g. credit card company). Concurrent with or prior to issuing the deposit/collateral/Bond/security the financing party (e.g. secondary credit provider) may request from the primary credit provider (or a set of primary credit providers) credit authorization(s) for the amount of the deposit/collateral/Bond/security.

According to some embodiments of the present invention, the securitization module may be further adapted to intermittently re-securitize an outstanding balance. A re-securitization may comprise of initiating a credit request and receiving a credit authorization.

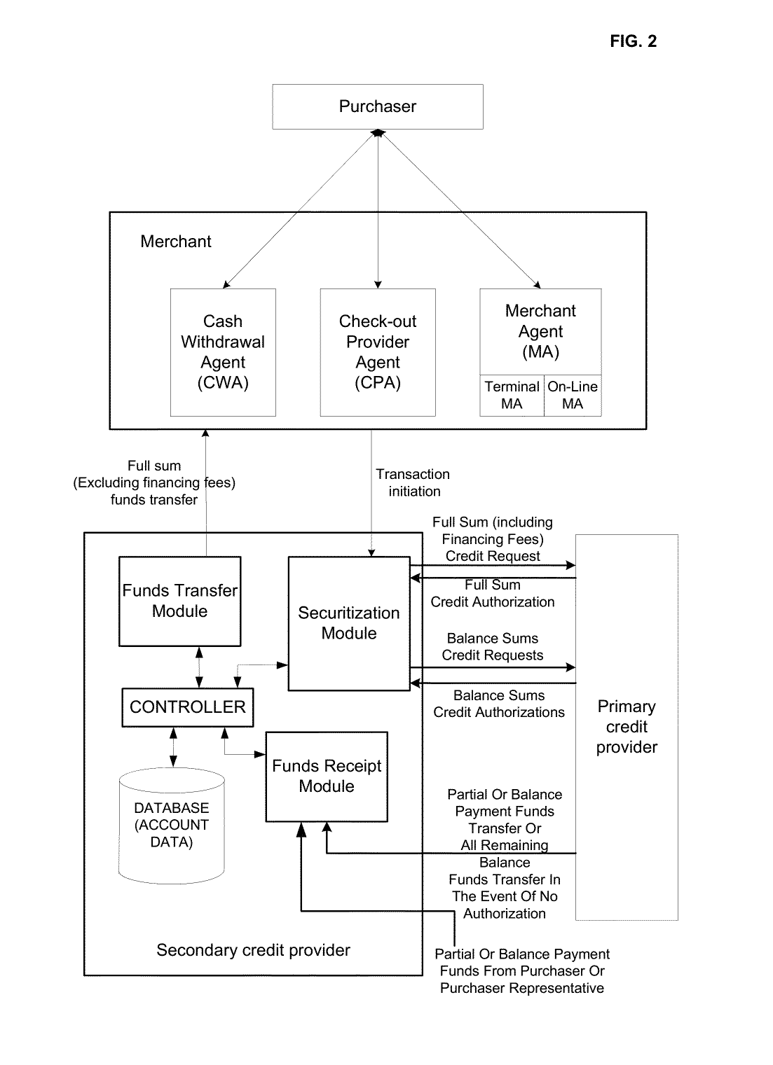

In FIG. 2 there is shown, in accordance with some embodiments of the present invention, a table describing the modules of an exemplary system for facilitating transactions/securities. The purchaser initiates a transaction through a Cash Withdrawal Agent (CWA), a Check-out Provider Agent (CPA) or a Merchant Agent (MA) such as an On-Line Merchant Agent, a Terminal Merchant Agent or any other suitable means. The system's (Secondary Credit Provider's) Securitization Module then performs a full transaction sum credit authorization through the Primary Credit Provider, upon a successful credit authorization (securitization) it finances and transfers the entire transaction amount to the merchant, or first party using its funds transfer module. Based on the installment plan agreed to by the purchaser, the secondary credit provider intermittently (e.g. before each installment is due) requests balance sums credit authorizations. Each time a balance sum credit request is authorized the secondary credit provider re-securitizes the remaining balance excluding the current installment, requests the primary credit provider to transfer to it the sum of the current installment and receives it using its funds receipt module. If a balance sum credit request is not authorized the secondary credit provider requests the primary credit provider to transfer to it the entire balance of the transaction, based on the last prior authorization made by the primary credit provider.

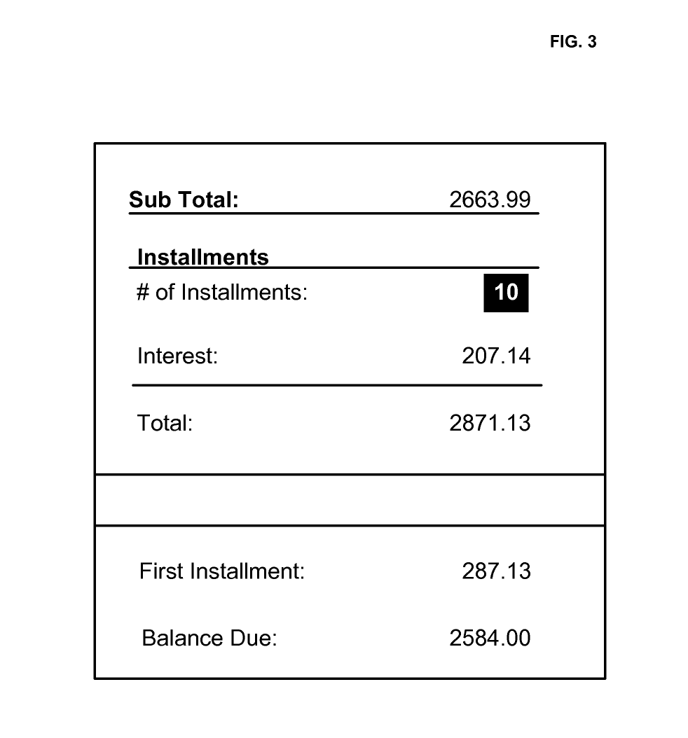

In FIG. 3 there is shown, in accordance with some embodiments of the present invention, an image of an exemplary transaction payment arrangement agreement wherein, based on the sub total of the transaction, the number of installments and the calculated interest; the amount of the first installment and the balance sum (after payment of the first installment) are calculated and presented.

According to some embodiments of the present invention, as part of a transaction spread to installments, a Consumer of goods and/or services and/or monetary means (e.g. cash), may request that a secondary credit provider pay the merchant the cost of the purchased goods and/or services. Said secondary credit provider may be any third party willing to finance said transaction (e.g. any financial institution, the merchant himself, any other individual(s) or entities).

According to some embodiments of the present invention, the secondary credit provider may provide the Consumer with repayment terms (e.g. monthly payments/installments) for the principle amount to be paid by the secondary provider and/or for financing fees (e.g. interest or any other kind of fees). The secondary credit provider may securitize the amounts to be paid to the merchant, or first party, against a credit line provided to the Consumer by a primary credit provider (e.g. credit card issuer). Concurrent with or prior to payment to merchant, the financing party (e.g. secondary credit provider) may request from the primary credit provider credit authorization for the remaining amounts due, including financing fees (e.g. interest, commission, any other supplementary fee).

According to some embodiments of the present invention, the secondary credit provider may request from the primary credit provider partial payment of the authorized credit based on the agreed upon repayment terms between the secondary credit provider and the Consumer. Since each credit authorization expires either within a predefined period of time or based on some action, the secondary credit provider may re-securitize any remaining balance owed to it by the Consumer by intermittently re-requesting credit authorization for the remaining balance. Credit authorization may be performed prior to the previous authorization expiring, such as to eliminate any period of time the funds are not securitized.

According to some embodiments of the present invention, the above re-securitization and money transfer cycle may be re-executed until all due payments are transferred to the secondary credit provider. In the event of a re-securitization failure, said secondary credit provider may request the primary credit provider to transfer the full remaining balance from Consumer to it, based on the last prior credit securitization performed.

According to further embodiments of the present invention, by re-securitization of some or all of the remaining balance owed to the secondary credit provider, just prior to, in parallel or just after purchaser's/cash-withdrawer's payment of each installment (i.e. prior/in parallel/after the expiration [time or action initiated] of each former credit securitization), risk of non-collectable sums may be reduced or minimized.

According to some embodiments, the merchant may be a retailer of goods, real estate, cash and/or a provider of services such as: (1) financial services, (2) banking services, (3) leasing services, (4) communication services, (5) medical services, (6) travel services, (7) currency exchange service, or any other goods or services. The merchant may provide Customer with goods or services: (1) at a manned point of sale (e.g. cash register), (2) through an automated apparatus (e.g. product dispenser, automatic teller machine, etc.), (3) through an online e-commerce site or through an online checkout application, and/or (4) via a mobile commerce system, or through any other commerce venue known now or to be devised in the future.

According to some embodiments, a retailer may also provide financial services, for example loaning or otherwise providing currency to a Customer. According to some embodiments, the merchant of goods and/or services may act as the secondary credit provider. For example a retailer, based on securitization provided by one or more primary credit providers, may provide a Customer with financing for: (1) an instant cash loan; (2) a purchase, rental or leasing of a product; and/or (3) a service. According to some embodiments secondary credit provider could be any bank(s), and/or accredit union, and/or any financial institution(s), and/or any other entities, and/or individual(s).

According to some embodiments, the securitization and re-securitization systems and methods described herein may be performed by a separate commercial entity from the funding party. The separate securitizing entity may provide the funding parties with securitization services as described herein. In other words, the secondary credit providers described herein may be implemented, in some embodiments, as two or more separate entities, one or more that supply the funds while a separate entity supplies the securitizations and re-securitizations described herein. In such embodiments, the interactions with the consumer and/or merchants (or first parties), may be through either type of entity or both. Accordingly, there may be a secondary credit provider that supplies installment/security services as described in this disclosure by supplying the funds for payment while using a separate service to securitize and re-securitize the funds, and/or there may be a secondary credit provider that supplies installment/security services as described in this disclosure by supplying the securitization and re-securitization services while contacting other parties to supply the funds against the securitizations performed. Further, a single “securitizing” entity may provide securitization services as described herein for multiple different funding parties/platforms. References herein to “secondary credit provider” should be understood to also describe such embodiments, i.e. when the funding and securitization are performed by separate entities.

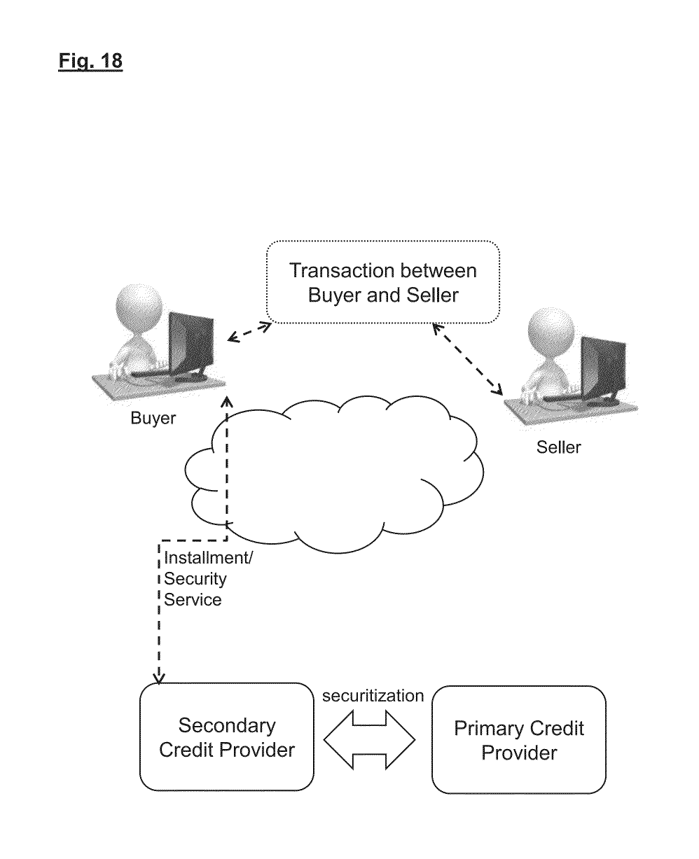

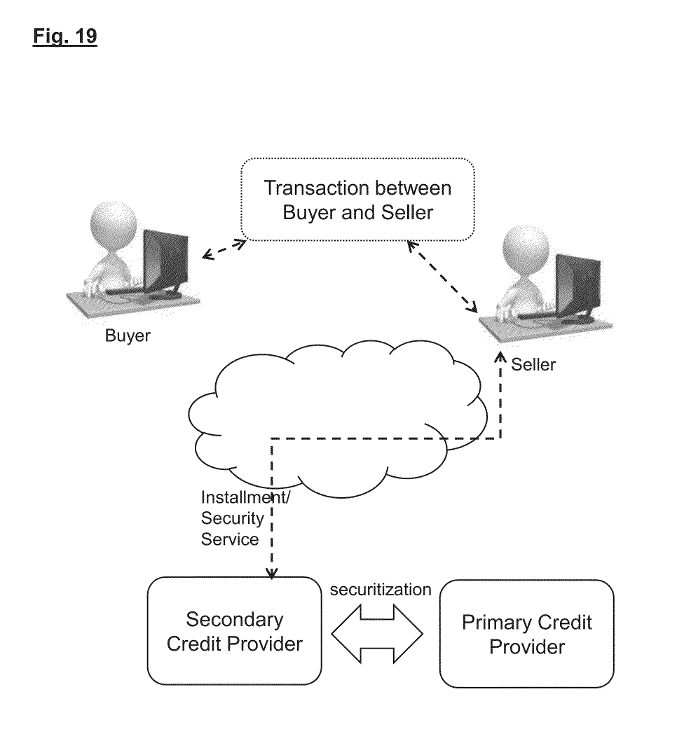

According to further embodiments the merchant or first party may be a private individual or individuals, or an organization acting as a private individual(s). In other words, a secondary credit provider may provide the installment and security services described herein to private individuals doing business amongst themselves. In such scenarios, a party to a negotiation/transaction may elicit the services of the secondary credit provider to provide installments or a security for one of the parties to the transaction. The secondary credit provider may be approached by either a seller/lender and/or a purchaser/borrower/user [see FIGS. 18-19]. The secondary credit provider's services may be based on a previous/ongoing relationship with one or more of the parties (e.g. a membership, account, profile etc. with the secondary credit provider) and/or on an ad-hoc basis.

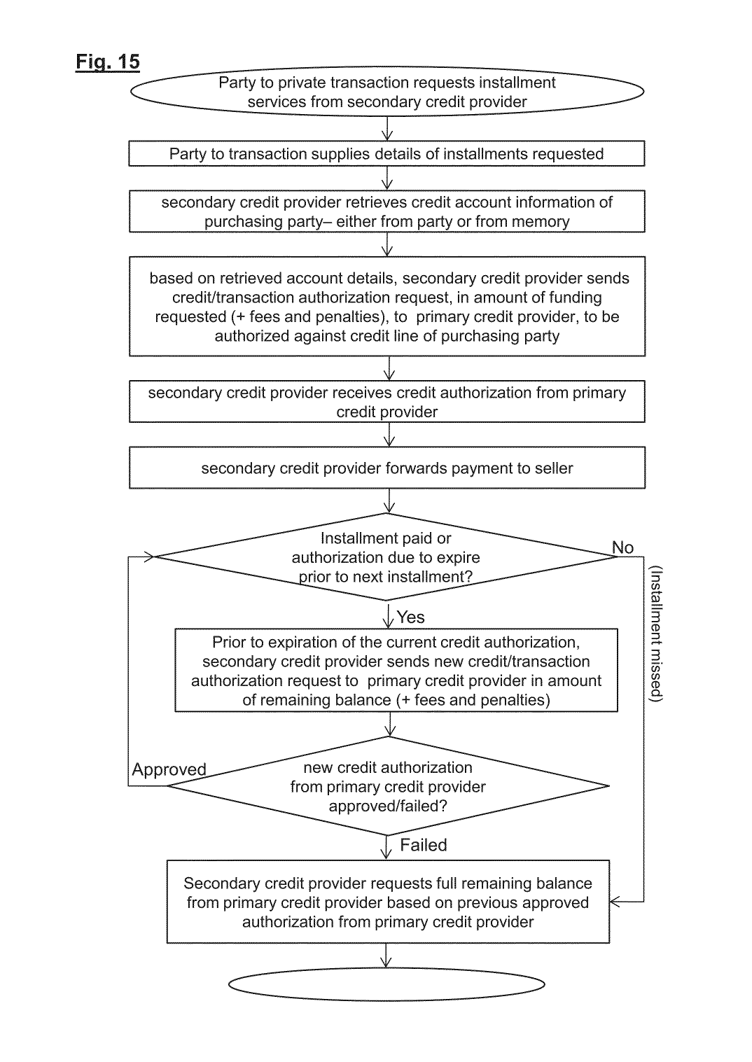

An exemplary process of providing installment and/or security services to individuals doing business amongst themselves, in accordance with some embodiments of the present invention, is presented in the flowchart marked FIG. 15. As can be seen in the flowchart, according to some embodiments, the secondary credit provider may receive the details of the transaction/security and details of one or more accounts of a party to the transaction with one or more primary credit providers. Prior to forwarding the funds/security, the secondary credit provider may secure the amount of the transaction/security against one or more credit lines of the purchaser/borrower/user with one or more primary credit providers. Upon a successful credit authorization for the amount in question, with one or more primary credit providers of the purchaser/borrower/user, the secondary credit provider may forward the amount of the transaction or security to the merchant/other-party, minus any fees/commissions. According to some embodiments of the present invention, a repeating cycle of re-securitizations may be initiated as described herein, wherein each cycle may comprise: a re-securitization of the remaining balance; and a request for the current payment, based on to the terms pre-agreed upon by Consumer, to be transferred to the secondary credit provider (e.g. through a credit line provided to the Consumer by a primary credit provider). According to further embodiments, fees and/or commissions may be collected from the purchaser, either instead or in addition to fees/commissions paid by the seller.

According to some embodiments of the present invention, said repeating cycle may terminate after all due payments were transferred to the secondary credit provider. In the event of a re-securitization failure, said secondary credit provider may request the primary credit provider to transfer the full remaining balance from the Consumer to it, based on the last prior credit securitization performed. Credit authorization may be performed prior to the previous authorization expiring, such as to eliminate any period of time the funds are not securitized. As stated herein in general, the secondary credit provider may be comprised from two or more entities in such scenarios, wherein one or more entities supply the funds and a separate entity supplies and performs the securitizations and re-securitizations of the funds.

For example, consider two parties that have negotiated a sale of one individual's used car to the other. One or both of these parties may contact a secondary credit provider to arrange payment for the car in installments. The secondary credit provider may: (1) collect the relevant information (sale details and details of one or more primary credit provider accounts of the buyer), (2) obtain credit authorization for the amount of the purchase with the one or more primary credit providers, (3) settle terms with the parties, including fees, commissions, penalties, payment schedule and so on, (4) forward the funds (minus any relevant fees/commissions) to the seller, (5) receive partial payments from the buyer, (6) re-securitize a remaining balance with the primary credit provider. (7) In the event of a re-securitization failure, said secondary credit provider may request the primary credit provider to transfer the full remaining balance from the buyer to it, based on the last prior credit securitization performed. Credit authorization may consistently be performed prior to the previous authorization expiring, such as to eliminate any period of time the funds are not securitized.

According to some embodiments, in such situations involving private transactions, a secondary credit provider may be registered before the primary credit provider as the “merchant of record” for the transaction. The secondary credit provider may further be a PSP (Payment Service Provider) or PI (Payment institution).

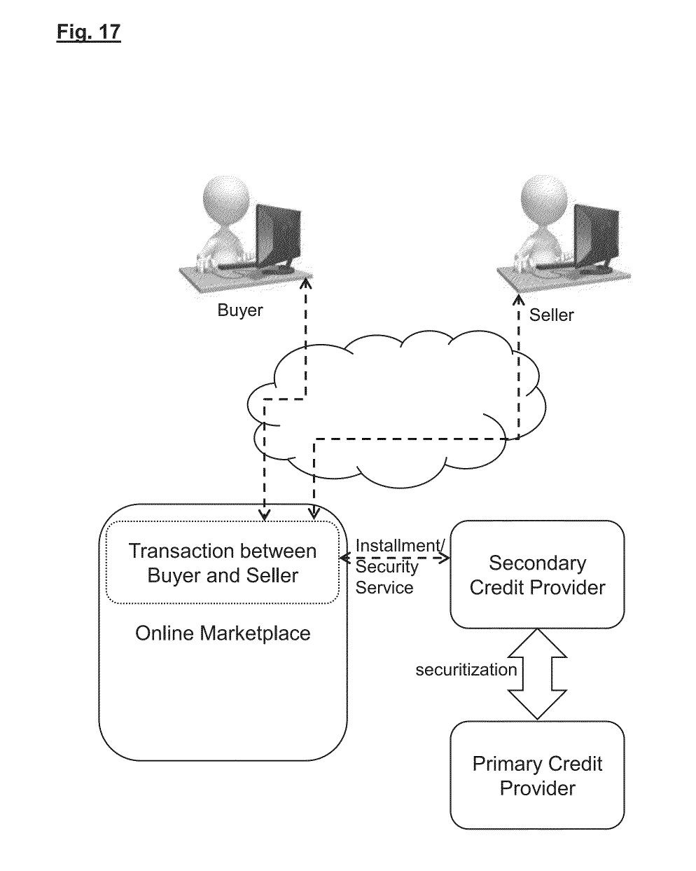

According to yet further embodiments, the transaction or security between the two individuals, may be associated with an organized marketplace, which may be an online marketplace (e.g. Ebay™, Craigslist™) and the funding/payment/security methods and systems described above may be offered/facilitated through, or in conjunction/association with, the organized marketplace [see FIG. 17]. For example, the interface of the organized marketplace may include a control element for making a purchase in installments using a secondary credit provider's services. In another example, an online marketplace for rentals may include a control element for arranging to deposit a security for a rental agreement using the services of a secondary credit provider as described herein. The control element may identify the secondary credit provider or may offer the service from the organized marketplace itself, relying on the secondary credit providers services behind the scenes. In other words, within the interface provided by the Online Marketplace for negotiation and/or settlement of transactions, there may be provided control elements/links/pointers for users to request installment and/or security/securitization services. Such control elements may be simple links to a secondary credit provider which provides such services or advertisements for such a secondary credit provider. Interaction with the control elements/links/pointers may then lead to an interface of the secondary credit provider who may then negotiate and supply the requested installment and/or security/securitization services. In other embodiments, the marketplace itself may provide the services, in which case the interface for requesting, negotiating and receiving installment and/or security/securitization services may be integral to the online marketplace interface for negotiation and/or settlement of transactions, e.g. an “installment” button. In such embodiments, the online marketplace may receive securitization and/or funding for the installment and/or security/securitization services from a secondary credit provider. According to further embodiments, the secondary credit may also provide technical support and/or hardware/software for the implementation of the services at the online marketplace.

It should be understood that the descriptions in this application in relation to an online marketplace may also be applied to online services and/or forums which are not inherently (or intended as) marketplaces, yet experience a degree of commerce in their activity. For example, a social networking site (e.g. Facebook™, Tweeter™, Instagram™, Linkedin™) may experience commercial activity between its users within the framework of the site. In such a social networking site, for example, there may be an “installment” and/or “security/collateral” button, which may be designed to provide, or link to, secondary credit provider services as described herein.

According to further embodiments, the funding/payment/security methods and systems described above may be offered/facilitated by a separate application, device or system, possibly designed to interface with organized online marketplaces, to differing degrees. For example the application may fully integrate into the organized marketplace, such that the features offered by the secondary credit provider become integrated functions of the organized marketplace. In another example, the application is merely linked to the marketplace by an advertisement or other linking mechanism, such that the users of the marketplace contact the secondary credit provider separately to elicit its services. Obviously, many other arrangements may be implemented between the secondary credit provider and the organized marketplace. Equally, it should be understood that the organized marketplace may receive a fee or other consideration for the customers the secondary credit provider receives from the marketplace. Alternatively, the marketplace may pay the secondary credit provider a fee for providing its services within the marketplace.

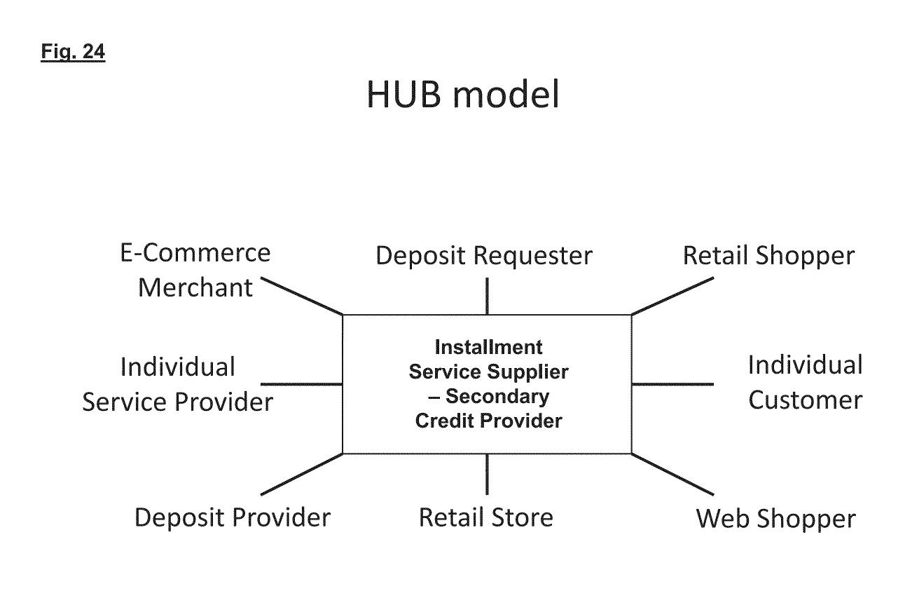

According to further embodiments, a single secondary credit provider may offer installment and/or security services to more than 1 marketplace, possibly using a single identifying marker (branding—e.g. Pay It Simple™) [see FIG. 24].

According to yet further embodiments the funding/payment/security methods and systems described above may be offered/facilitated as stand alone services, with and/or without subscription/registered service.

According to some embodiments, in such situations involving private transactions occurring within the framework of an organized marketplace, a secondary credit provider may be registered before the primary credit provider as the “merchant of record” for the transaction and/or the marketplace may be registered before the primary credit provider as the “merchant of record” for the transaction. The secondary credit provider or marketplace may further be a PSP (Payment Service Provider) or PI (Payment institution).

According to some embodiments, the primary credit provider may be a credit card issuer, a financial institution, a credit union, and/or any other entity extending and/or committing credit and/or payment services to and on behalf of the Customer.

According to some embodiments a Customer may establish facilities or availability for transaction payment by the secondary creditor (secondary credit provider) either during or in advance of a given transaction. As part of establishing a Payer arrangement with a secondary creditor or the organizer of the secondary credit, the Customer may provide personal and financial information including: (1) name, (2) address, (3) an identification number (e.g. Social Security Number), and (4) one or more identifiers of primary creditor accounts (e.g. credit card accounts) against which the secondary creditor may secure repayment of payments made or other consideration extended by secondary creditor on behalf of the Customer. According to further embodiments, the Customer may be provided a set of primary account indicators representing primary credit lines which may be used to securitize transaction related costs, and the Customer may designate: (1) a preference for primary account order or priority when securitizing a transaction amount; (2) a preferred ratio for splitting securitization of a transaction amount across multiple primary creditor accounts; and (3) any other rules or parameters which may be used by a securitization module according to embodiments of the present invention when authorizing a transaction on behalf of the Customer. According to further embodiments, a Customer may be provided an identifier and use a primary creditor account of one or more other persons and/or entity(ies), for example a company, a family member and/or a friend, such person(s) and/or entities, who have consented to having their credit facilities/accounts being utilized or leveraged by the Customer.

A computer system according to embodiments may include a Customer/user interface, optionally a web interface, through which a Customer may establish and/or adjust one or more secondary creditor accounts. Establishing and adjusting may include providing or changing information and parameters as described above, and designating or re-designating: (1) a preference for primary account order or priority when securitizing a transaction amount; (2) a preferred ratio for splitting securitization of a transaction amount across multiple primary creditor accounts; and (3) any other rules or parameters which may be used by a securitization module according to embodiments of the present invention when authorizing a transaction on behalf of the Customer.

Establishment of a secondary creditor account according to embodiments may include the issuance of a transaction facilitating token such as a: (1) credit card of the secondary credit provider, (2) a digital token or the like to be used for authentication in online transactions, (3) a mobile application component for use with mobile payments, and/or (4) any other payment facilitating tokens or instruments known today or to be devised in the future. The token may be specific to a given Customer account and may be used by the Customer when initiating a transaction according to embodiments of the present invention. The token may include one or a set of Customer identifiers usable by a computerized transaction authorization system, according to embodiments, to initiate steps required to authenticate and authorize a transaction in which the Customer wishes to engage.

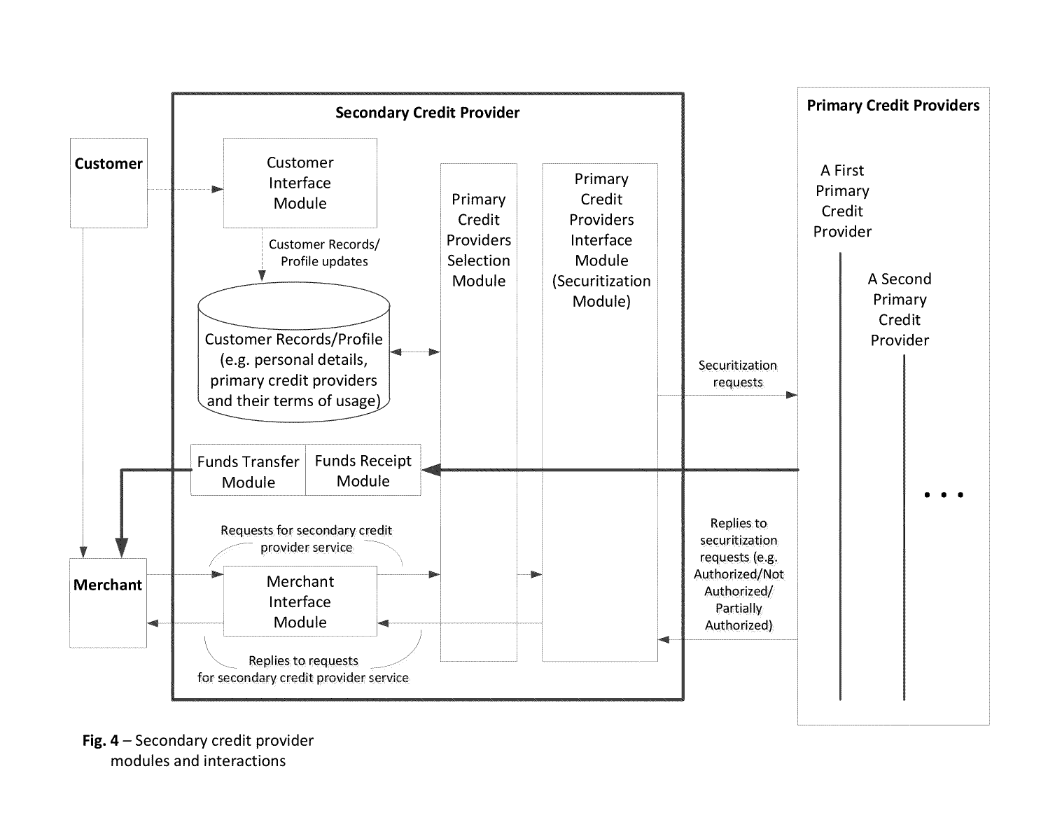

In FIG. 4 there is shown, in accordance with some embodiments of the present invention, a table describing the modules of an exemplary system for facilitating transactions comprising, a consumer interface module, a merchant interface module and a primary credit provider(s) interface module. The consumer uses the consumer interface module to access and edit/update the secondary credit provider's consumer/customer records/profile, adding or changing personal details, his list of primary credit providers, their terms of usage and or any other attributes relating to his own details and/or his primary credit provider(s). The merchant interface module is used by the merchant for sending requests for secondary credit provider service, for consumer transaction funding, and receiving replies to these requests. The primary credit providers interface module (securitization module) sends securitization requests, that are based on the transaction details supplied by the merchant and the consumer's primary credit providers profile, to one or more primary credit provider(s) and receives in return replies from the one or more primary credit providers approached (e.g. Authorized/Not Authorized/Partially Authorized).

According to some embodiments of the present invention, a charge-back procedure may be initiated as a result of a product or service not provided, rightly returned or for any other reason which may justify refund of some or all of the purchase or financing fees, to the purchaser and/or to other parties. The financing party (e.g. Secondary credit provider) may retrieve the ‘charged back’ transaction details and may accordingly debit the merchant on part of or on the entire purchase amount. Out of the debited amount, it may order the primary credit provider to refund, or otherwise refund, some of or the entire purchaser's already paid amounts and some of or the entire amounts, not yet paid to it by the purchaser.

According to some embodiments of the present invention, said method may be used to externally orchestrate, or may allow or enable for the collaboration of one or more independent, external or internal entities—of any Consumer, credit provider, merchant, acquirer, issuer or other, in order to facilitate the Installments method described herein. Furthermore an external or modular financing of these Installments transactions (e.g. by an external/3^{rd} party/secondary credit provider) may be utilized and may enable for one or more secondary credit financing sources, or for the withdrawal of cash from different merchants, which may or may not be specifically customized for this type of service and may or may not be the withdrawal transaction's financing entity.

According to some embodiments of the present application, there may be provided a transaction system adapted to facilitate credit transactions between a merchant, or first party, and a Consumer of goods and/or services and/or monetary means (e.g. cash), which may be initiated at or through any point of access (e.g. online, point of sale, automatic teller machine).

As part of the transaction system, or functionally associated with the transaction system, there may be provided a merchant agent, checkout provider agent or cash withdrawal agent module. The merchant agent, checkout provider agent or cash withdrawal agent module, which may be accessed through any point of access (e.g. online, point of sale, automatic teller machine/ATM), may be adapted to offer the Consumer repayment terms for the principle amount to be paid to the merchant, or first party, by the financing party (e.g. secondary credit provider) and for financing fees (e.g. interest or any other fees), which costs may be spread over a period of time (e.g. monthly payments, installments), and initiate such a transaction upon approval by said Consumer.

As part of the transaction system, or functionally associated with the transaction system, there may be provided a securitization module. The securitization module may be adapted to securitize the amounts to be paid to the merchant plus financing fees by requesting credit authorization for the full amount from a primary credit provider (e.g. a credit card issuer or any other credit provider), possibly by using a credit line provided to the Consumer. Said securitization module may be further adapted to request from the primary credit provider credit authorization for the remaining amounts due, including financing fees, concurrent with or prior to payment to the merchant.

According to some embodiments of the present invention, as part of a transaction cost/amount being spread to installments, a Consumer of goods and/or services and/or monetary means (e.g. cash), may utilize a payment mechanism or token, such as a payment card or online payment application, provided by a secondary credit provider. Using the secondary credit provider's payment mechanism may cause the secondary credit provider to: (1) authenticate details of the transaction; (2) check availability of one or more primary credit-lines sufficient to cover the transaction amount, and (3) subject to (1) and (2), pay the merchant some or all of the cost of the purchased goods and/or services. The secondary credit provider may be any third party willing to finance said transaction (e.g. pay the merchant).

According to some embodiments of the present invention, the transaction amount, provided by the secondary credit provider, including financing fees, may be securitized, for example against one or more credit lines provided to the Consumer by one or more primary credit providers. Based on said securitization, secondary credit providers may pay the merchant the transaction amount, usually excluding financing fees. According to some embodiments, an amount securitized against any one of the one or more primary credit lines may be a fixed amount, a fixed percentage or a dynamically calculated amount. According to embodiments where an outstanding balance is securitized against two or more credit lines, an amount selected for each one of the two or more primary lines may be dynamically selected so as to mitigate a risk of any of the primary credit providers declining to securitize the portion selected for their securitization.

As part of the transaction system, or functionally associated with the transaction system, there may be provided a money transfer module. The money transfer module may be adapted to order, upon said primary credit provider authorization, the transferring of the full purchase/cash-withdrawal amount excluding financing fees from a secondary credit provider to the merchant.

According to some embodiments of the present invention, said securitization module may be further adapted to re-securitize any remaining balance owed to the secondary credit provider by the Consumer by intermittently re-requesting credit authorization for the remaining balance. Said money transfer module may be further adapted to request, upon re-securitization of the remaining balance, the primary credit provider to transfer the amount of the current payment according to pre-agreed repayment terms (e.g. monthly payments) from Consumer to the secondary credit provider.

According to some embodiments of the present invention, the above re-securitization and money transfer cycle may be re-executed until all due payments are transferred to the secondary credit provider. In the event of a re-securitization failure, said money transfer module may be further adapted to request the primary credit provider to transfer the full remaining balance from Consumer to the financing party (e.g. secondary credit provider), based on the last prior credit securitization performed.

According to further embodiments of the present invention, said securitization module may be adapted to re-securitize some or all of the remaining balance owed to the secondary credit provider, just prior to, in parallel or just after purchaser's/cash-withdrawer's payment of each installment (i.e. prior/in parallel/after the expiration [time or action initiated] of each former credit securitization) thus reducing or minimizing the risk of non-collectable sums.

According to some embodiments of the present invention, partial payment of the transaction's cost may be received either from the primary credit provider or directly from a purchaser of the goods or service. According to some embodiments of the present invention, upon a re-securitizing failure, a secondary credit provider may receive full balance payment from the primary credit provider.

According to some embodiments of the present invention, a partial payment received by the secondary credit provider may be one of a set of equal or one of a set of non-equal partial payments. Sizes and timings of received payments may be determined according to a predefined payment schedule, further, the partial payment may be substantially equal to the funded amount plus financing fees, divided by the number of payments to be made.

According to some embodiments of the present invention a repeating cycle of re-securitizations may be initiated, wherein each cycle may comprise: a re-securitization of the remaining balance; and a request for the current payment, based on to the terms pre-agreed upon by Consumer, to be transferred to the secondary credit provider (e.g. through a credit line provided to the Consumer by a primary credit provider).

According to some embodiments of the present invention, said repeating cycle may terminate after all due payments were transferred to said secondary credit provider. In the event of a re-securitization failure, said secondary credit provider may request the primary credit provider to transfer the full remaining balance from the Consumer to it, based on the last prior credit securitization performed.

According to some embodiments of the present invention, securitizing and/or re-securitizing of the cost(s) of the transaction over a data network may consist of issuing a credit request and receiving credit authorization. According to some embodiments of the present invention, intermittent receipt of partial payment may further include receipt of transaction related financing costs and/or receipt of commission costs.

According to some embodiments, it is possible to use different cycles for requesting authorization and request for payment from one or more primary credit providers. The normal cycle may be a monthly cycle, however, it may be different if needed for any reason. A cycle for request for authorization could be, for example, 25 (twenty five) days.

A Cycle for request for payment may be, for example, one month. To demonstrate:

1. If the purchase occurred on March 1 and authorization was requested and received on March 1.

2. On March 25 re-securitization may be requested and receive authorization. Payment is requested and received on April 1. In this manner, if request for authorization is be rejected there will remain an additional 5 days to take remedial action, for example, repeatedly requesting authorization and/or requesting another credit card from consumer. In case of a black-out or other act major, there will probably remain sufficient time, because such obstacles are usually temporary.

3. On April 19 re-securitization may be requested and receive authorization. Payment is requested and received on May 1.

4. On May 14 re-securitization may be requested and receive authorization. Payment is requested and received on June 1.

5. On June 8 re-securitization may be requested and receive authorization. Payment is requested and received on July 1.

6. On July 3 re-securitization may be requested and receive authorization. Payment is requested and received on August 1.

7. On July 28 re-securitization may be requested and receive authorization. (NOTE: on this step there is no request for payment).

8. On August 22 re-securitization may be requested and receive authorization. Payment is requested and received on September 1.

9. On September 16 re-securitization may be requested and receive authorization. Payment is requested and received on October 1.

10. On October 11 re-securitization may be requested and receive authorization. Payment is requested and received on November 1.

11. On November 6 re-securitization may be requested and receive authorization. Payment is requested and received on December 1.

12. On December 20 re-securitization may be requested and receive authorization. Payment is requested and received on January 1.

13. On January 4 re-securitization may be requested and receive authorization. Payment is requested and received on February 1.

14. On January 29 re-securitization may be requested and receive authorization. (NOTE: on this step there is no request for payment).

15. On February 22 re-securitization may be requested and receive authorization. Payment is requested and received on March 1.

16. On March 18 re-securitization may be requested and receive authorization. Payment is requested and received on April 1.

17. On April 13 re-securitization may be requested and receive authorization. Payment is requested and received on May 1.

Accordingly, in such an example, double authorization may only occur in the last 5 (five) days of 30 day authorizations. It is very probable that in 25 days authorization will be taken out of the records of the primary credit provider.

In the above example there is always a 5 day difference/overlap between the current authorization being made and the expiration of the one presently in effect. These 5 days of time (in this example) give assurance that: (i) in case of a denial of authorization there is sufficient time to take remedial actions such as: re-attempting securitization, contacting the customer for another source of securitization (i.e. another primary credit line such as another card of the customer, or a card of any other individual(s) and/or entity, with prior or current approval from such individual(s)/entity(ies)); (ii) in most cases of blackout/brownout, or any other catastrophic failure in the invention's system or external systems functionally associated with it (for example communication system), 5 days are sufficient time for power-up; (iii) in case of a massive hacker/malware/cyber attack, or an internal software failure, which may be related to an internal or an external event (e.g. the bug 2K in the year 2000); (iv) any other internal and/or external event(s). it should be understood that the 5 day period is exemplary and may similarly be 3 days, 4 days, 2 days, 5 hours and so forth. Any time period prior to expiration of the previous authorization may be implemented. Such a time period may include the necessary time buffer dependent upon the circumstances.

According to further embodiments, the system may allow for the adjustment of the cycle of payment and authorization in order to meet head to head with possible threats. According to yet further embodiments, such payment and authorization cycles may be dynamically adjusted in the case of perceived different or additional threats; in response to a request made by one of the parties (consumer/merchant/secondary credit provider); and/or in response to a change in the regulatory environment by governmental or semi governmental bodies, by major primary credit systems, or any other entity.

According to some embodiments of the present invention the second credit provider may be adapted to handle a charge-back procedure initiated as a result of a product or service not provided, rightly returned or for any other reason which may justify refund of some or all of the purchase or financing fees, to the purchaser and/or to other parties. Secondary credit provider may be further adapted to retrieve the ‘charged back’ transaction details and may accordingly debit the merchant on part of or on the entire purchase amount. Out of the debited amount, it may order the primary credit provider to refund, or may otherwise refund, some of or the entire purchaser's already paid amounts and some of or the entire amounts, not yet paid to it by the purchaser.

According to some embodiments of the present invention, said system may be adapted to externally orchestrate, or may allow or enable, for the collaboration of one or more independent, external or internal entities—of any Consumer, credit provider, merchant, credit card acquirer, credit card issuer, organizer of transaction with installments payments, or other, in order to facilitate the Installments method described herein. Furthermore, said system may be adapted to allow for the utilization of external or modular financing of these Installments transactions (e.g. by an external/3^{rd} party/secondary credit provider) and thus may enable one or more secondary credit financing sources, and/or for the withdrawal of cash from different merchants, which may or may not be specifically customized for this type of service and may or may not be the withdrawal transaction's financing entity.

According to some embodiments of the present invention, a payment plan may be amended and custom-made to Consumer, e.g. postponing first payment, varying the payment schedule according to a pre-determined plan agreed with Consumer and more. According to some embodiments, a payment plan may be amended at any time after the conclusion of the agreement with the consumer in order to accommodate current needs of the consumer. According to some embodiments, such an amendment of the payment plan may be a predetermined function, or may take place as a result of a predetermined function of certain outside factors (e.g. change in the prime rate for loans).

According to further embodiments, the consumer may prepay the entire outstanding balance or prepay part of the outstanding balance—in which case his payment plan may be amended in one, or more, of several ways, including: reducing the amounts of at least some of the installments, reducing the number of installments, and so on.

According to some embodiments of the present invention, a payment may be accepted, and/or securitization may be done, from a different source if current payment is declined, for example from Consumer's additional credit card or from another person(s) or entities following Consumer's request.

According to some embodiments of the present invention, a transaction may be funded through the merchant as opposed to an external funder, i.e. the merchant may act as the secondary credit provider.

According to some embodiments of the present invention, a transaction funding may be divided between several collectors (for example, the merchant, the funding body, the clearing body, or any other body).

According to some embodiments of the present invention, a down-payment for leasing or mortgages may be funded by dividing the down-payment cost to installments (fully or partially) when purchasing or leasing, for example, a car, a boat, a house and more through the system. Such funding of down-payment may be provided by any primary credit provider(s).

According to some embodiments of the present invention, the system may be used for giving out loans in installments which may be collected directly through the credit or debit card used by the consumer for the monthly payments, directly to the Consumer's bank account or in any other way. Such credit may be securitized by a primary creditor as described herein (e.g. by issuer of credit card, a credit union or a bank, a non-bank credit card issuer).

According to some embodiments of the present invention, a Consumer may open an account in the system where they may update the details of additional credit cards in order for the system to divide the ongoing authorizations/re-securitizations as well as the actual collection, between the different cards according to the Consumer's instructions or a formula within the system, to divide the risk and increase the chances of approving the transactions, or according to the credit card type (Platinum before Gold etc.).

According to some embodiments of the present invention, opening an account may enable the system to automatically request re-securitization or approval for collection from another card listed in the Consumer's account if one of the re-securitization or collection procedures from the first card has been declined in the duration of the Consumer's funding period.

According to some embodiments of the present invention, the system may know how to execute the transaction through a specific card or to divide it between a number of cards which the Consumer may have registered in his account in order to maximize the consumer benefits existing in the different cards according to the Consumer's instructions or according to the system's decision in a way that may maximize the benefits to the Consumer (for example, collecting air miles, reimbursement of funds (e.g. cash back etc.).

According to some embodiments of the present invention, a Consumer may re-finance/re-securitize all of the existing transactions through the purchaser's account on the system, combining or dividing some or all the remaining balance in the different transactions.

According to some embodiments of the present invention, an automatic system may be created to divide funding of an external entity between several financing bodies (simulate funding syndicate) and distributing the funding between the bodies according to a pre-determined module to be agreed upon with the financing bodies as well as attaching the authorization of the Primary Credit Provider to the financing bodies relative to the risk and the extent of their commitments in the transaction.

According to some embodiments of the present invention, the system may divide the securitization requests according to an algorithm, which algorithm may enable a higher chance of approval in the securitization process (for example, by dividing one securitization request into two: one for the due installment and one for the remaining amount).

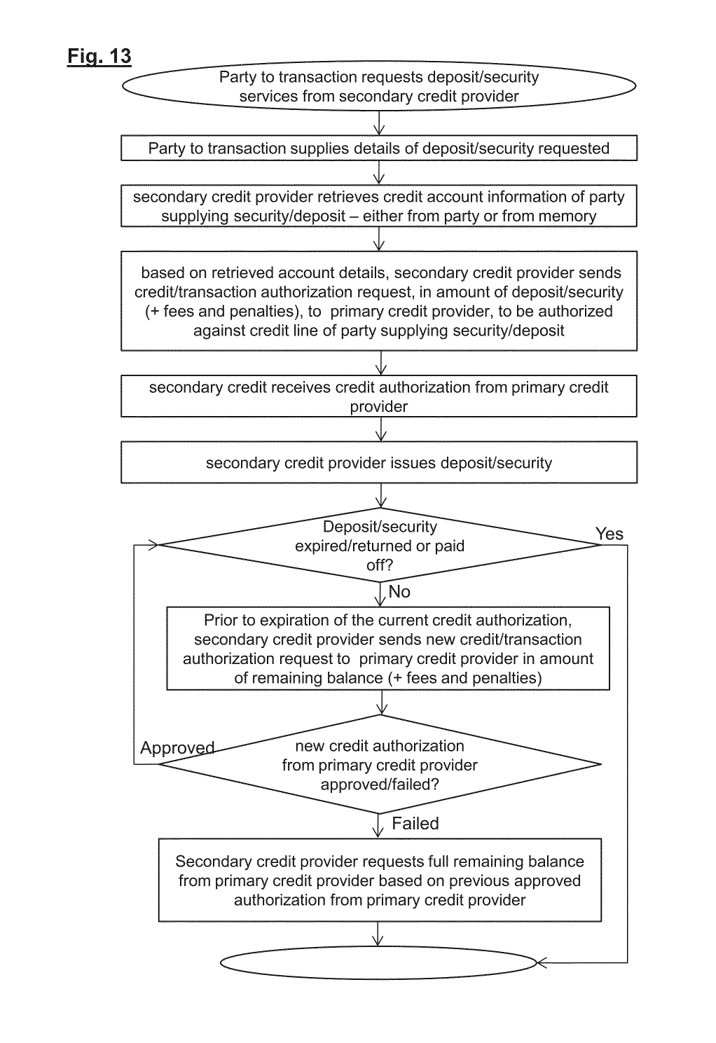

According to further embodiments, the above described securitization and re-securitization systems and methods may be used to provide a consumer/customer/user with a deposit/collateral/Bond/security for a third party. An exemplary process of providing a deposit/security, in accordance with some embodiments of the present invention, is presented in the flowchart marked FIG. 13. As can be seen in the flowchart, the amount of the deposit/collateral/Bond/security, including financing fees (e.g. interest, commission, any other supplementary fee(s)) and possible penalties may be securitized against a credit line provided to the Consumer by a primary credit provider (e.g. credit card company). Concurrent with or prior to issuing the deposit/collateral/Bond/security the financing party (e.g. secondary credit provider) may request from the primary credit provider (or a set of primary credit providers) credit authorization(s) for the amount of the deposit/collateral/Bond/security. The financing party may transfer to the third party actual funds as a deposit and/or may only transfer to the third party a commitment to reimburse or transfer the funds in the event of a realization to the security.

Since each credit authorization expires either within a predefined period of time or based on some action, the secondary credit provider may re-securitize any remaining balance of the security by intermittently re-requesting credit authorization for the remaining balance. Credit authorization may be performed prior to the previous authorization expiring, such as to eliminate any period of time the funds are not securitized.

According to some embodiments of the present invention, the financing party (e.g. secondary credit provider) may request from the primary credit provider or the consumer/customer/user partial payment of the issued security based on the agreed upon repayment terms between the secondary credit provider and the consumer/customer/user. The security may also be maintained without intermittent repayment, such that the original amount is re-securitized prior to the expiration of the previous authorization.

In the event of a re-securitization failure, said secondary credit provider may request the primary credit provider to transfer the full remaining balance from the Consumer to it, based on the last prior credit authorization performed. According to further embodiments of the present invention, prior to requesting the transfer of the full amount from the primary credit provider, a securitization may be attempted from a different source, for example from the Consumer's additional primary credit providers or from another person(s) or entities willing to provide their credit line(s). furthermore, upon the event of a realization of the security/bond/collateral the third party may be paid by the secondary credit provider the amount he/she is entitled to based on the terms of the security. The secondary credit provider may, in turn, demand the paid/confiscated/seized amounts of the security from the customer/consumer. In the event that the customer/consumer cannot or does not repay the paid/confiscated/seized amounts, the secondary credit provider may claim the amounts from the primary credit provider based on the most recent credit securitization/re-securitization.

According to some embodiments, a security agreement secured by a secondary credit provider may include terms for the realization of the security, e.g. the third party may be required to give notice to the consumer/customer and/or an opportunity for the consumer/customer to correct the fault/damage justifying the realization of the security. Alternatively, the third party may be required to present evidence or other documentation in order to realize the security. In such cases, the secondary credit provider may require the third party present the relevant evidence/documentation prior to paying/releasing the security, all as agreed in the security agreement and/or as practiced by the secondary credit provider, and/or based on its policies.

For example, a point of sale (POS) software supplier who also supplies the point of sales for his software, may normally require a security for the hardware from his customers. In place of the normal deposit, the POS software supplier, or his customer, may contact a secondary credit provider, as described herein, to supply the deposit/security for the hardware. The secondary credit provider may supply the deposit/security, while securing the amount of the deposit/security against one or more credit line(s) provided to the customer/consumer by one or more primary credit provider(s). Prior to expiration of the credit authorization(s) from the primary credit provider(s), the secondary credit provider may re-securitize an outstanding security balance, such as to eliminate any period of time the funds are not securitized. In the event of a re-securitization failure, said secondary credit provider may request the primary credit provider to transfer the full remaining balance from Consumer to it, based on the last prior credit securitization performed.

According to some embodiments, a request to, or the interaction with, the secondary credit provider may be initiated and/or executed by the third party requesting the security. In other words, a party desiring a security from a consumer may himself contact the secondary credit provider, transfer details of the consumer's primary credit provider and relevant account details to the secondary credit provider and request the secondary credit provider to supply the security. The secondary credit provider may, in turn, securitize the security amount with the primary credit provider, as described herein, and, upon securitization with the primary credit provider, provide the security to the requesting party. The secondary credit provider may then continue re-securitizing the amount of the security with the primary credit provider.

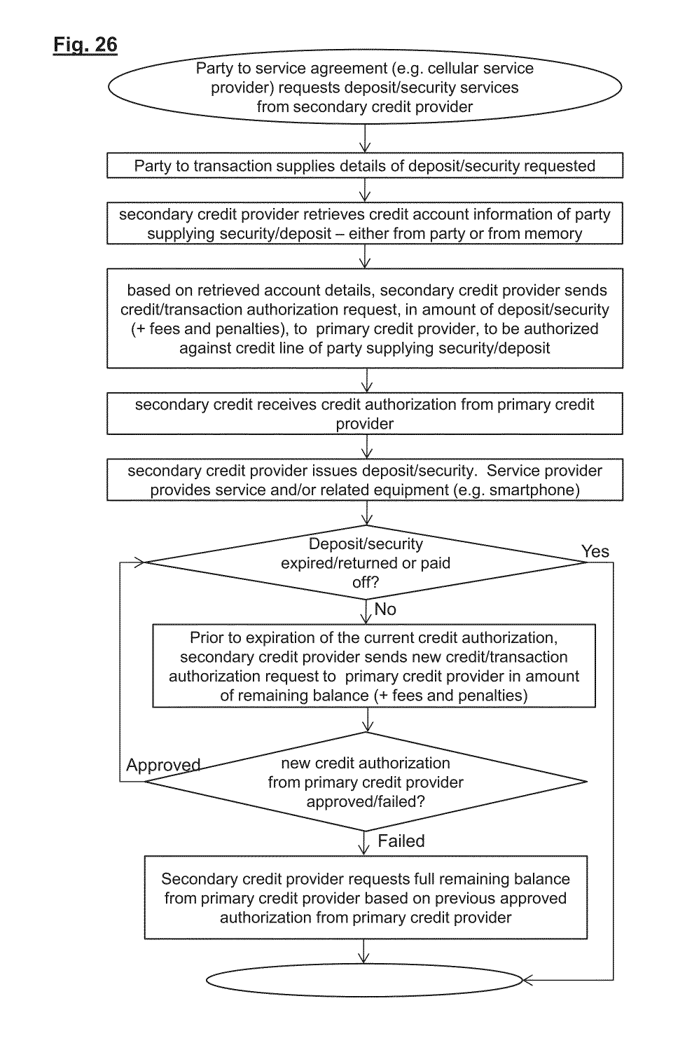

According to further embodiments, the above described securitization and re-securitization systems and methods may be used to provide a consumer/customer/user with a deposit/security for a service which requires a deposit/security from some or all of its customers in order to receive service and/or related equipment (e.g. a cellular phone service, cable/satellite tv service, etc.), possibly in conjunction with the use/lease/rent/purchase of hardware/equipment in relation to the service (e.g. a smartphone, satellite dish, etc.). An exemplary process of providing a deposit/security for a service which requires a deposit/security from some or all of its customers in order to receive service, in accordance with some embodiments of the present invention, is presented in the flowchart marked FIG. 26. As can be seen in the flowchart, the amount of the deposit/security, including financing fees (e.g. interest, commission, any other supplementary fee(s)) and possible penalties, may be securitized against a credit line provided to the Consumer by a primary credit provider (e.g. credit card company). Concurrent with or prior to issuing the deposit/security, the financing party (e.g. secondary credit provider) may request from the primary credit provider (or a set of primary credit providers) credit authorization(s) for the amount of the deposit/security. The financing party may transfer to the service provider actual funds as a deposit/security and/or may only transfer to the service provider a commitment to reimburse or transfer the funds in the event of a realization to the security/deposit.

According to some embodiments, the deposit/securities for a service which requires a deposit/security from some or all of its customers in order to receive service may be used to secure/cover service charges (e.g. monthly cellular phone usage charges, satellite service charges, etc.) for the service and/or a cost of hardware/equipment (e.g. smartphone, satellite dish, etc.) in relation to the service.

Since each credit authorization expires either within a predefined period of time or based on some action, the secondary credit provider may re-securitize any remaining balance of the security by intermittently re-requesting credit authorization for the remaining balance. Each credit authorization may be performed prior to the previous authorization expiring, such as to eliminate any period of time the funds are not securitized.

According to some embodiments of the present invention, the financing party (e.g. secondary credit provider) may request from the primary credit provider or the consumer/customer/user partial payment of the issued security based on the agreed upon repayment terms between the secondary credit provider and the consumer/customer/user. The security may also be maintained without intermittent repayment, such that the original amount is continuously re-securitized prior to the expiration of the previous authorization.

In the event of a re-securitization failure, the secondary credit provider may request the primary credit provider to transfer the full remaining balance from the Consumer to it, based on the last prior credit authorization performed. According to further embodiments of the present invention, prior to requesting the transfer of the full amount from the primary credit provider, a securitization may be attempted from a different source, for example from the Consumer's additional primary credit providers or from another person(s) or entities willing to provide their credit line(s). Furthermore, upon the event of a realization of the deposit/security the service provider may be paid by the secondary credit provider the amount he/she is entitled to based on the terms of the deposit/security. The secondary credit provider may, in turn, demand the paid/confiscated/seized amounts of the deposit/security from the customer/consumer. In the event that the customer/consumer cannot or does not repay the paid/confiscated/seized amounts, the secondary credit provider may claim the amounts from the primary credit provider based on the most recent credit securitization/re-securitization.

According to some embodiments, a deposit/security agreement secured by a secondary credit provider may include terms for the realization of the security, e.g. the service provider may be required to give notice to the consumer/customer and/or an opportunity for the consumer/customer to correct the fault/damage justifying the realization of the deposit/security. Alternatively, the service provider may be required to present evidence or other documentation in order to realize the deposit/security. In such cases, the secondary credit provider may require the service provider present the relevant evidence/documentation prior to paying/releasing the deposit/security, all as agreed in the deposit/security agreement and/or as practiced by the secondary credit provider, and/or based on its policies.

According to some embodiments, the funding of deposits/securities for a service which requires a deposit/security from some or all of its customers in order to receive service may be requested by the customer. According to further embodiments, the funding/securing of deposits/-securities for a service which requires a deposit/security from some or all of its customers in order to receive service may be requested/elicited by the service provider. In other words, in place of requesting a deposit from customers, a service provider which previously required a deposit/security from some or all of its customers in order to receive service may now request details of a credit line with a primary credit provider from the customers and secure the service charges and/or related equipment/-hardware charges using the services of a secondary credit provider as described herein, or by performing the securitizations and re-securitizations described herein themselves.

For example, a cellular service provider who also supplies smartphones/tablets to its customers, may normally require a security/deposit for the hardware and/or service from its customers. In place of the normal deposit, the cellular service provider, or its customer, may contact a secondary credit provider, as described herein, to supply the deposit/security for the equipment and/or service charges. The secondary credit provider may supply the deposit/security, while securing the amount of the deposit/security against one or more credit line(s) provided to the customer/consumer by one or more primary credit provider(s). Prior to expiration of the credit authorization(s) from the primary credit provider(s), the secondary credit provider may re-securitize an outstanding security balance, such as to eliminate any period of time the funds are not securitized. In the event of a re-securitization failure, said secondary credit provider may request the primary credit provider to transfer the full remaining balance from Consumer to it, based on the last prior credit securitization performed and/or may cancel/mitigate the security (e.g. cause the service provider to stop providing service). In other words, the principles of the present invention may be used to replace deposits/-securities provided to service providers by their customers in order to receive service and/or for related equipment/hardware, with revolving credit authorizations from a primary credit provider (as described herein as securitization and re-securitization prior to expiration).

According to some embodiments, above described securitization and re-securitization systems and methods may be used to provide a security deposit and/or bond associated with the lease/rental-contract of a real estate property (e.g. apartment, condo, house, store, warehouse, workshop). It should be understood that security deposit in this context might also include other amounts/securities a renter is required to provide the owner of the property (e.g. first and last month rent). The amount of the security deposit and/or bond, including financing fees (e.g. interest, commission, any other supplementary fee(s)) and possible penalties may be securitized against a credit line provided to the renter of the property by a primary credit provider (e.g. credit card company). Concurrent with or prior to issuing the security deposit and/or bond the financing party (e.g. secondary credit provider) may request from the primary credit provider (or a set of primary credit providers) credit authorization(s) for the amount of the security deposit and/or bond (possibly including financing fees (e.g. interest, commission, any other supplementary fee(s)) and possible penalties). The financing party may transfer to the owner of the property actual funds as a security deposit and/or bond and/or may only transfer to the owner of the property a commitment to reimburse or transfer the funds in the event of a realization to the security.

Since each credit authorization expires either within a predefined period of time or based on some action, the secondary credit provider may re-securitize any remaining balance of the security by intermittently re-requesting credit authorization for the remaining balance. Credit authorization may be performed prior to the previous authorization expiring, such as to eliminate any period of time the funds are not securitized.

In the event of a re-securitization failure, said secondary credit provider may request the primary credit provider to transfer the full remaining balance from the renter to it, based on the last prior credit authorization performed. According to further embodiments of the present invention, prior to requesting the transfer of the full amount from the primary credit provider, a securitization may be attempted from a different source, for example from the renter's additional primary credit providers or from another person(s) or entities willing to provide their credit line(s). Furthermore, upon the event of a realization of the security deposit and/or bond the third party may be paid by the secondary credit provider the amount he/she is entitled to based on the terms of the security deposit and/or bond. The secondary credit provider may, in turn, demand the paid/confiscated/seized amounts of the security deposit and/or bond from the renter. In the event that the renter cannot or does not repay the paid/confiscated/seized amounts, the secondary credit provider may claim the amounts from the primary credit provider based on the most recent credit securitization/re-securitization.

According to some embodiments, a rental agreement secured by a secondary credit provider may include terms for the realization of the security deposit and/or bond, e.g. the owner of the property may be required to give notice to the renter and/or an opportunity for the renter to correct the fault/damage justifying the realization of the security deposit and/or bond. Alternatively, the owner of the property may be required to present evidence or other documentation in order to realize the security deposit and/or bond. In such cases, the secondary credit provider may require the owner of the property to present the relevant evidence and/or documentation prior to paying/releasing the security, all as agreed in the security agreement and/or as practiced by the secondary credit provider, and/or based on its policies.

According to some embodiments, such security deposit services and/or security deposit securitization services may be offered as a separate service, directly to renters and/or owners of properties and/or via real estate agents or online real estate services/listings. For example, a rental marketplace (e.g. Craigslist™) may offer users of the online service security deposit services and/or security deposit securitization services as described above. According to further embodiments, a secondary credit provider may provide the online rental marketplace and/or real estate agents the funding and/or securitization services behind the scenes. According to other embodiments, the online rental marketplace and/or real estate agents may simply refer or otherwise connect between the renter/property-owner and the secondary credit provider (with or without taking a commission/fee from one or both of the sides). Clearly, one secondary credit provider may provide such services to more than 1 online rental marketplace and/or real estate agent and may further be branded in this field.

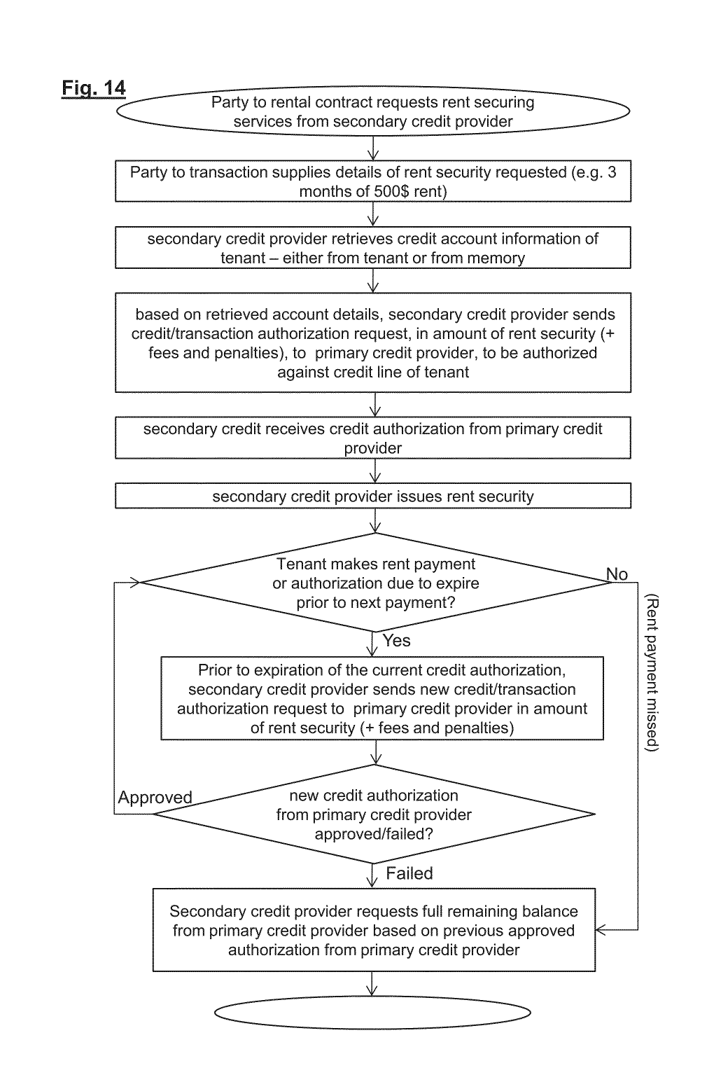

Reference is now made to FIG. 14. According to some embodiments, above described securitization and re-securitization systems and methods may be used to secure rental payments associated with the lease/rental-contract of a real estate property (e.g. apartment, condo, house, store, warehouse, workshop). It should be understood that such a securitization may be in addition to, instead of and/or partially instead of, the above described funding of a security deposit and/or bond associated with the lease/rental-contract. In such scenarios, the above described systems and methods may be used to securitize a given number of rental payments according to the lease/rental contract (e.g. 3 months rent, 6 months rent, 1 years rent, the entire rental period, etc.). An exemplary process of providing a securitization of rental payments, in accordance with some embodiments of the present invention, is presented in the flowchart marked FIG. 14. As can be seen in the flowchart, the amount of the rental payments secured, including financing fees (e.g. interest, commission, any other supplementary fee(s)) and possible penalties may be securitized against a credit line provided to the renter of the property by a primary credit provider (e.g. credit card company). Concurrent with or prior to approving the securitization of the rental payments, the financing party (e.g. secondary credit provider) may request from the primary credit provider (or a set of primary credit providers) credit authorization(s) for the amount of the secured rental payments (possibly including financing fees (e.g. interest, commission, any other supplementary fee(s)) and possible penalties).

Since each credit authorization expires either within a predefined period of time or based on some action, the secondary credit provider may re-securitize any remaining balance of the secured rental payments by intermittently re-requesting credit authorization for the remaining balance. Credit authorization may be performed prior to the previous authorization expiring, such as to eliminate any period of time the funds are not securitized. Accordingly, the secured amount may be reduced each time a rental payment is made (e.g. in the event the entire rental period is secured) or may remain constant throughout the rental period, such that at any point in the rental period the rental payments of the next X months are secured by the secondary credit provider. In the event that the renter stops paying rent, the security may be realized to cover rental payments until the renter can be evicted or the payment of rent renewed and/or to cover any other damages the owner may incur.

In the event of a re-securitization failure, said secondary credit provider may request the primary credit provider to transfer the full remaining balance from the renter to it, based on the last prior credit authorization performed. According to further embodiments of the present invention, prior to requesting the transfer of the full amount from the primary credit provider, a securitization may be attempted from a different source, for example from the renter's additional primary credit providers or from another person(s) or entities willing to provide their credit line(s). Furthermore, upon the event of a realization of the security deposit and/or bond the owner of the property may be paid by the secondary credit provider the amount he/she is entitled to based on the terms of the lease/rental contract. The secondary credit provider may, in turn, demand the rental payment amounts from the renter. In the event that the renter cannot or does not repay the paid amounts, the secondary credit provider may claim the amounts from the primary credit provider based on the most recent credit securitization/re-securitization.

According to some embodiments, such rent security services may be offered as a separate service, directly to renters and/or owners of properties and/or via real estate agents or online real estate services/listings. All as described above in relation to rental contract security deposits, with the relevant modifications. Clearly, one secondary credit provider may provide such services to more than 1 online rental marketplace and/or real estate agent and may further be branded in this field.

According to some embodiments, above described securitization and re-securitization systems and methods may be used to secure peer-to-peer loans. The amount of the loan, or a portion thereof, including financing fees (e.g. interest, commission, any other supplementary fee(s)) and possible penalties may be securitized against a credit line provided to the loaner by a primary credit provider (e.g. credit card company). Concurrent with or prior to securing the loan the securing party (e.g. secondary credit provider) may request from the primary credit provider (or a set of primary credit providers) credit authorization(s) for the amount secured (possibly including financing fees (e.g. interest, commission, any other supplementary fee(s)) and possible penalties). The financing party may transfer to the lender a commitment to reimburse or transfer the funds in the event of a loaner fails to return the loan as agreed.

Since each credit authorization expires either within a predefined period of time or based on some action, the secondary credit provider may re-securitize any remaining balance of the loan secured by intermittently re-requesting credit authorization for the remaining balance. Credit authorization may be performed prior to the previous authorization expiring, such as to eliminate any period of time the funds are not securitized.

In the event of a re-securitization failure, said secondary credit provider may request the primary credit provider to transfer the full remaining balance from the loaner to it, based on the last prior credit authorization performed. According to further embodiments of the present invention, prior to requesting the transfer of the full amount from the primary credit provider, a securitization may be attempted from a different source, for example from the loaner's additional primary credit providers or from another person(s) or entities willing to provide their credit line(s). Furthermore, upon the event of a failure to return the loan as agreed, the lender may be paid by the secondary credit provider the amount he/she is entitled to based on the terms of the loan agreement. The secondary credit provider may, in turn, demand the paid amounts from the loaner. In the event that the loaner cannot or does not repay the paid amounts, the secondary credit provider may claim the amounts from the primary credit provider based on the most recent credit securitization/re-securitization.

According to some embodiments, a loan agreement secured by a secondary credit provider may include terms for the realization of the loan securitization by the secondary credit provider, e.g. the lender may be required to give notice to the loaner and/or an opportunity for the loaner to correct the breach of the loan agreement. Alternatively, the lender may be required to present evidence or other documentation in order to realize the security of the loan. In such cases, the secondary credit provider may require the lender to present the relevant evidence and/or documentation prior to paying the amounts, all as agreed in the loan agreement and/or as practiced by the secondary credit provider, and/or based on its policies.

According to some embodiments, such loan securing services may be offered as a separate service, directly to loaners and/or lenders in peer-to-peer arrangements and/or via peer-to-peer lending services/marketplaces. For example, a peer-to-peer lending marketplace (e.g. Fundingcircle.com™), may offer users of the online service loan securing services as described above. According to further embodiments, a secondary credit provider may provide the peer-to-peer lending marketplace the funding and/or securitization services behind the scenes. According to other embodiments, the peer-to-peer lending marketplace may simply refer or otherwise connect between the lender/loaner and the secondary credit provider (with or without taking a commission/fee from one or both of the sides). Clearly, one secondary credit provider may provide such services to more than 1 peer-to-peer lending marketplace and may further be branded in this field.

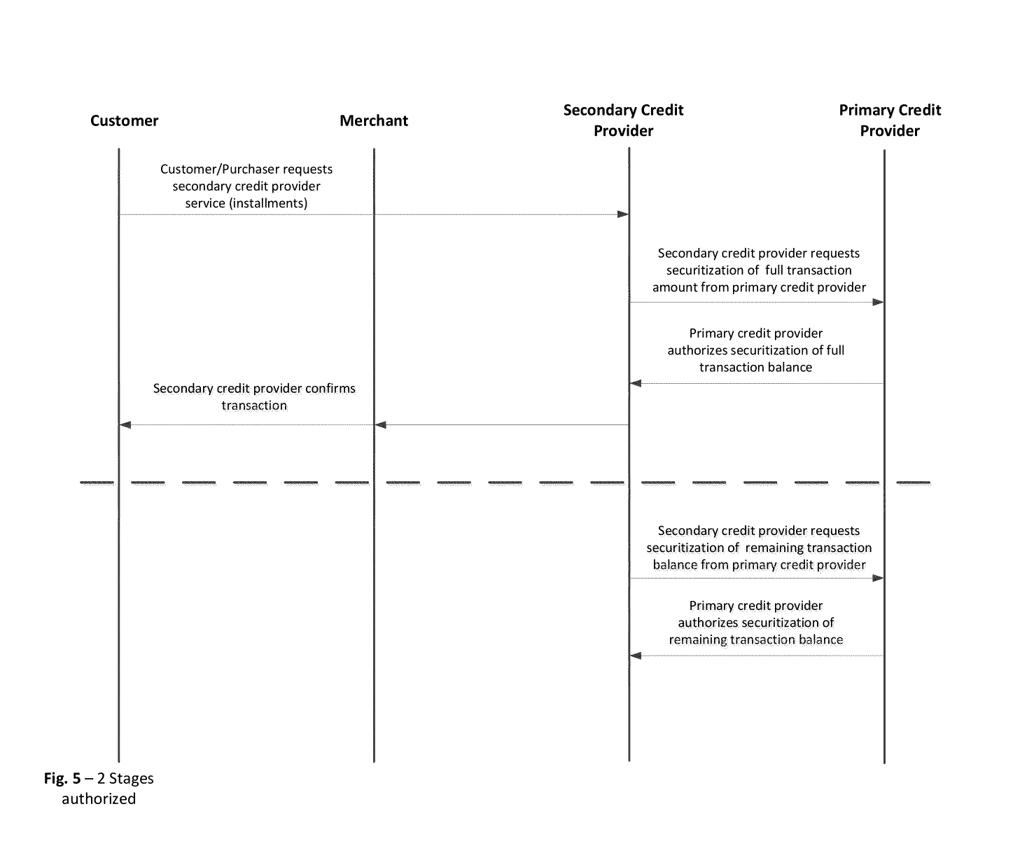

In FIGS. 5-12 there are shown, in accordance with some embodiments of the present invention, various exemplary primary credit provider securitization scenarios of an exemplary system for facilitating transactions.

In FIG. 5 there is shown, in accordance with some embodiments of the present invention, an exemplary two stage scenario wherein the primary credit provider authorizes both: the initial securitization of the full transaction amount, and the following remaining transaction balance sum(s).

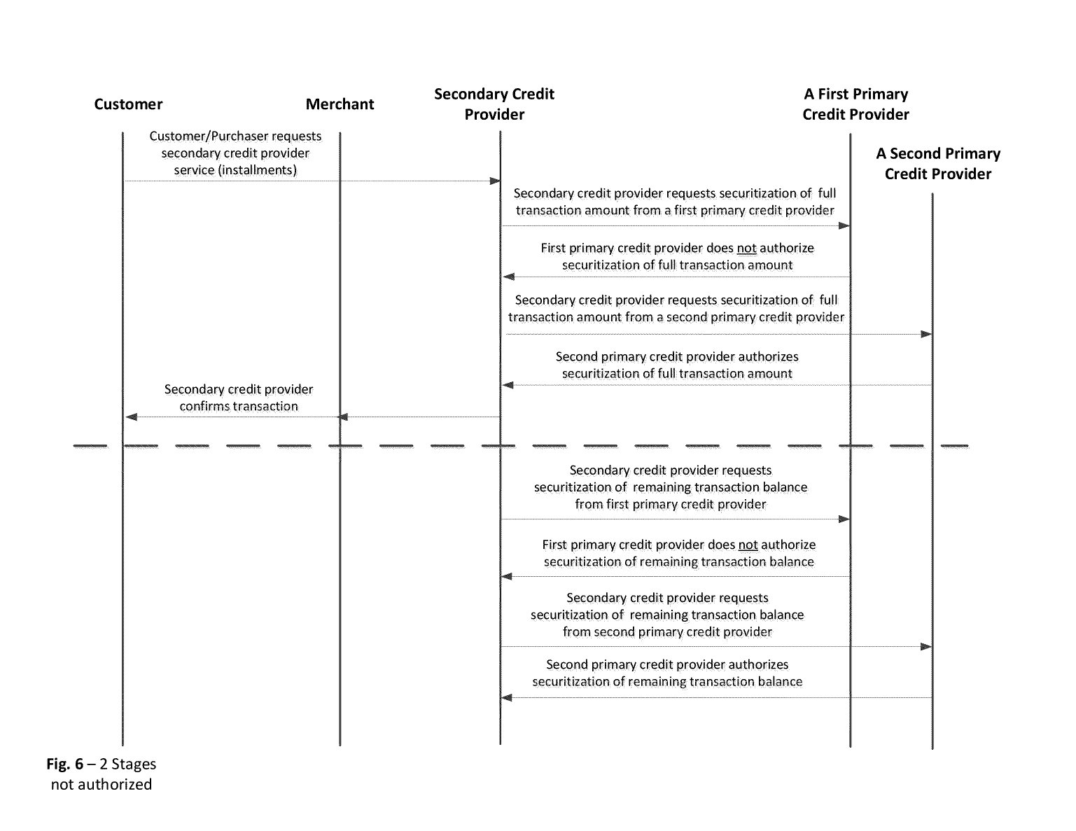

In FIG. 6 there is shown, in accordance with some embodiments of the present invention, an exemplary two stage scenario wherein the first primary credit provider does not authorize both: the initial securitization of the full transaction amount, and the following remaining transaction balance sum(s). Upon each failure to authorize, the secondary credit provider approaches a second primary credit provider (e.g. listed in the consumer's second credit provider's consumer records/profile) which authorizes the securitizations.

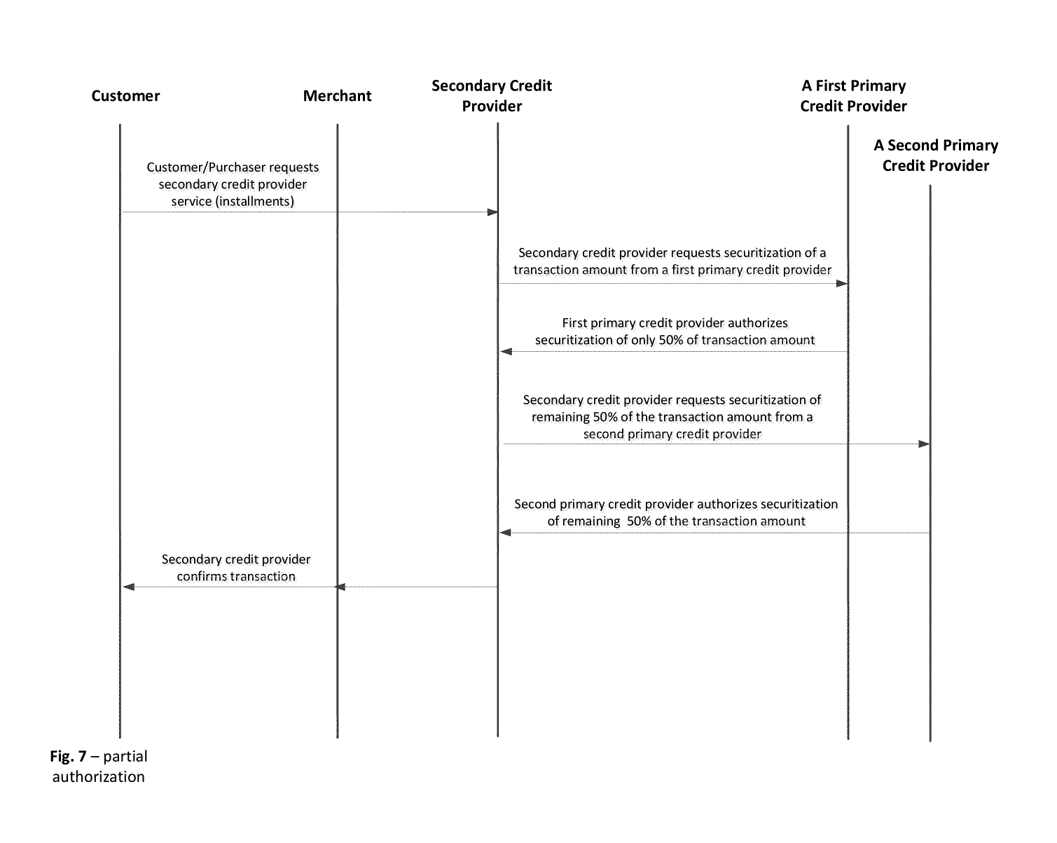

In FIG. 7 there is shown, in accordance with some embodiments of the present invention, an exemplary scenario wherein the first primary credit provider authorizes securitization of only 50% of the transaction amount. Upon failure to authorize the entire transaction amount, the secondary credit provider approaches a second primary credit provider (e.g. listed in the consumer's second credit provider's consumer records/profile) which authorizes the securitization of the remainder of the transaction amount.

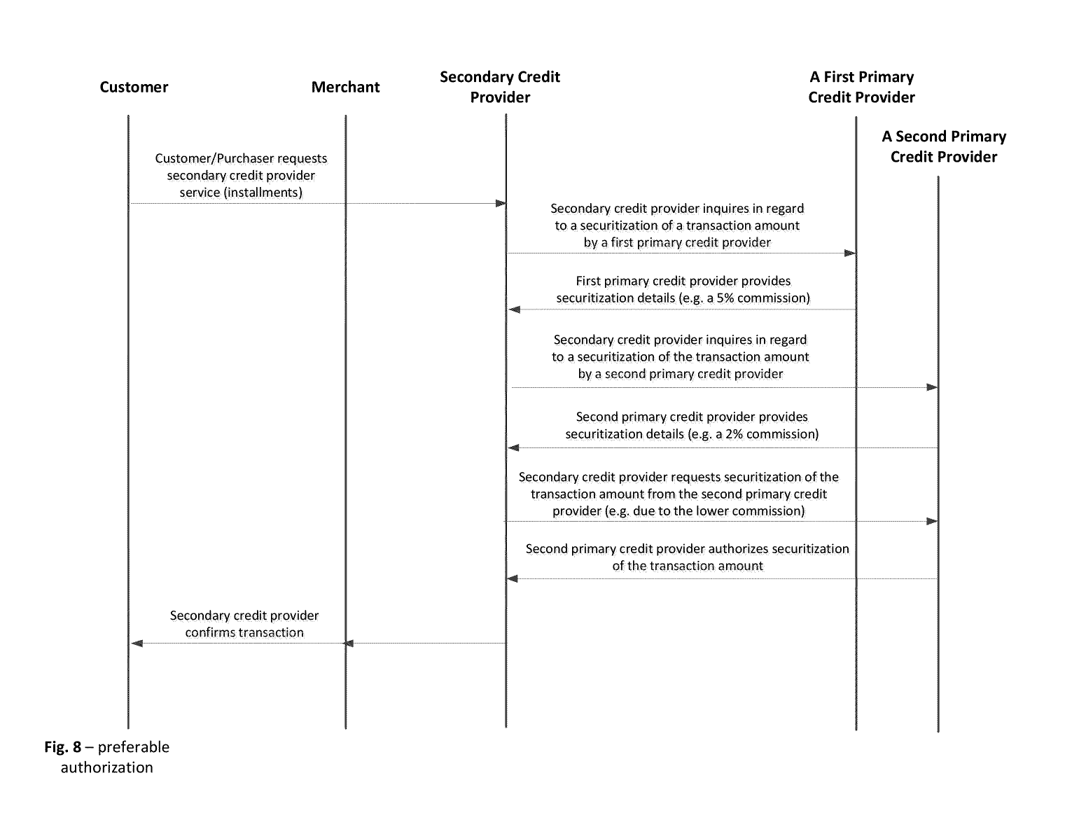

In FIG. 8 there is shown, in accordance with some embodiments of the present invention, an exemplary scenario wherein the secondary credit provider inquires in regard to a securitization of a transaction amount by the first primary credit provider and the first primary credit provider provides securitization details (e.g. a 5% commission). The secondary credit provider then inquires in regard to a securitization of a transaction amount by the second primary credit provider and the second primary credit provider provides securitization details (e.g. a 2% commission). Due to the preferred terms offered by the second primary credit provider the second credit provider proceeds to securitize the transaction with it rather than with the first primary credit provider.

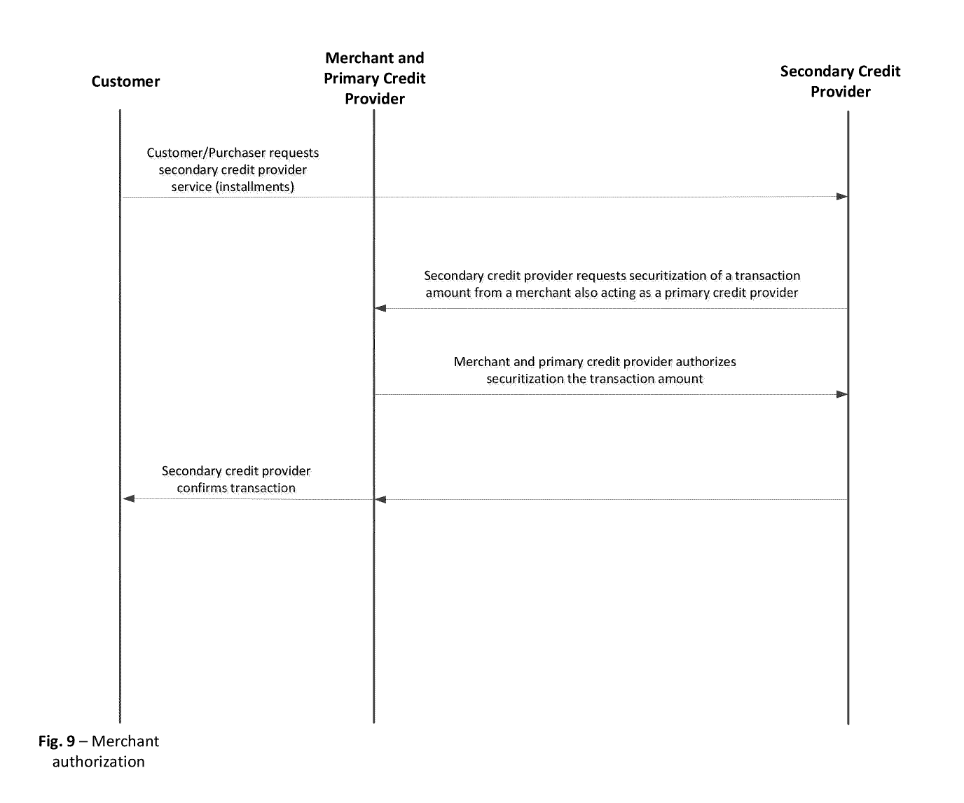

In FIG. 9 there is shown, in accordance with some embodiments of the present invention, an exemplary scenario wherein the merchant is the primary credit provider. The second credit provider requests and receives securitization authorization from the merchant, based on which authorization it funds the transaction.

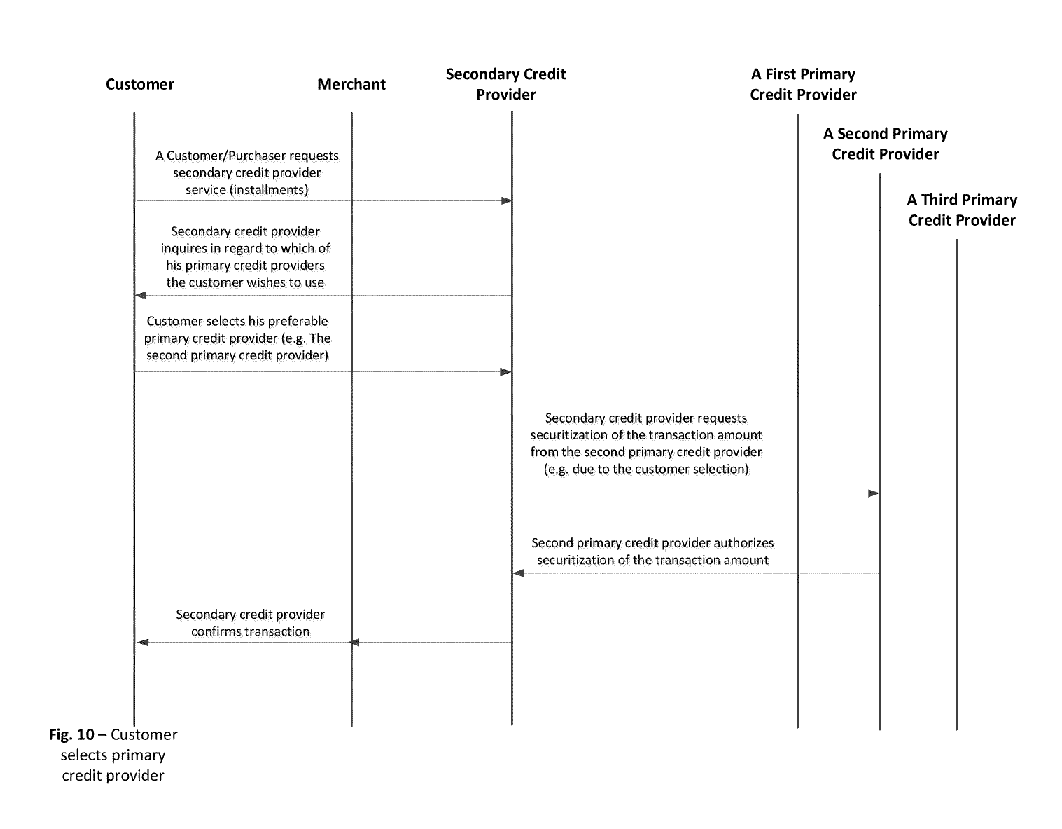

In FIG. 10 there is shown, in accordance with some embodiments of the present invention, an exemplary scenario wherein the merchant is the secondary credit provider and inquires with the consumer in regard to which of his primary credit providers (e.g. listed in the consumer's second credit provider's consumer records/profile) he wishes to use for securitization. Upon receipt of the consumer's selection of his preferable primary credit provider (e.g. The second primary credit provider) the secondary credit provider proceeds to securitize with the selected primary credit provider.

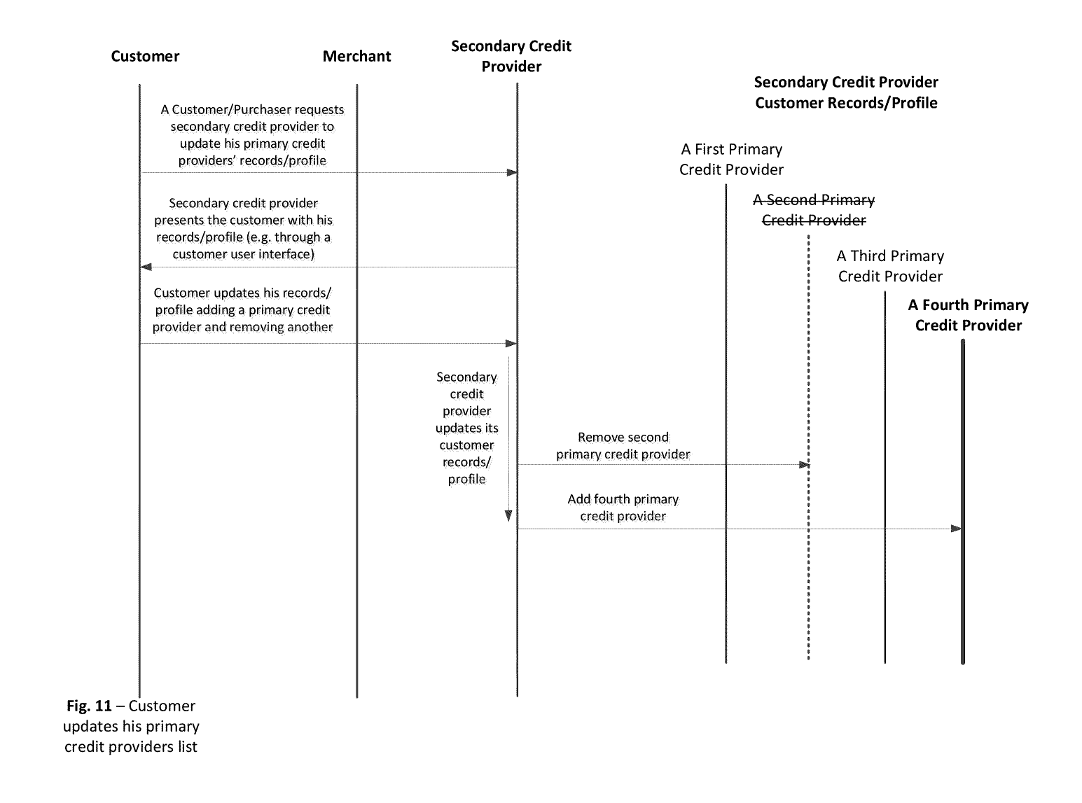

In FIG. 11 there is shown, in accordance with some embodiments of the present invention, an exemplary scenario wherein the consumer updates his secondary credit provider's records/profile adding a primary credit provider (the Fourth) and removing another (the Second).

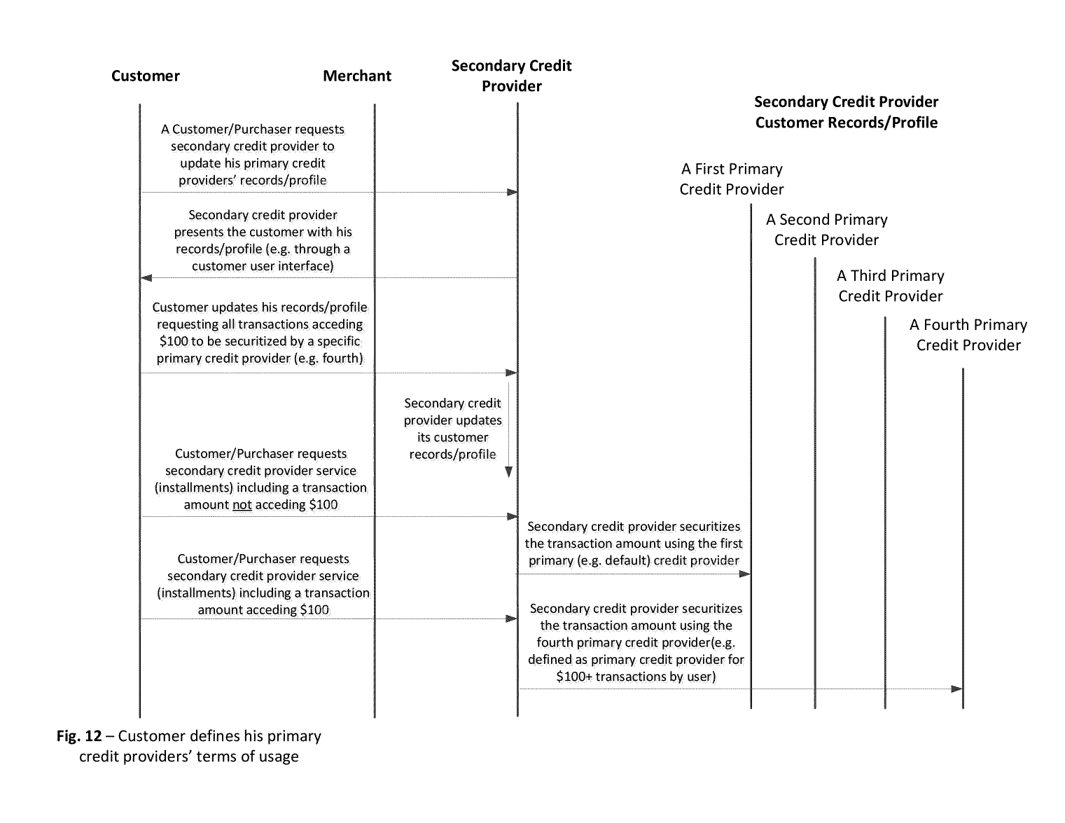

In FIG. 12 there is shown, in accordance with some embodiments of the present invention, an exemplary scenario wherein the consumer updates his secondary credit provider's records/profile requesting all transactions exceeding $100 to be securitized by a specific primary credit provider (the Fourth). Accordingly, a subsequent transaction of an amount not exceeding $100 is referred to other primary credit providers (First, Second or Third; First in this case), whereas a subsequent transaction of an amount exceeding $100 is referred to the specific primary credit providers designated by the consumer (the Fourth in this case).

According to some embodiments, the system, described herein, may be organized and structured as a “cloud” or partially as a “cloud”.

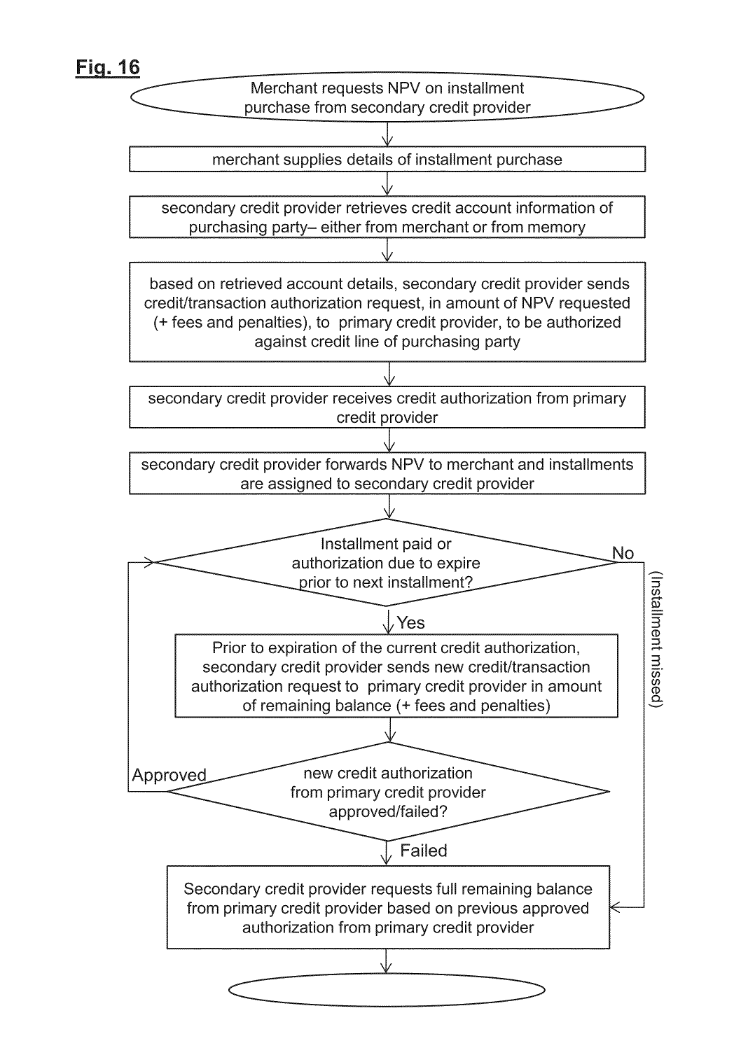

Reference is now made to FIG. 16. According to some embodiments, a secondary credit provider, as described herein, may use the securitization and re-securitization systems and methods described herein to offer an installment clearance type service to merchants and/or other parties owning a debt being paid in installments (e.g. a purchase of a merchants receivables). An exemplary process of providing an “installment clearance” (NPV) to merchants, in accordance with some embodiments of the present invention, is presented in the flowchart marked FIG. 16. As can be seen in the flowchart, the secondary credit provider may offer to currently pay the merchant/other-party an amount owed to the merchant/other-party and currently being paid to the merchant/other-party in installments, i.e. a net present value (NPV) or portion thereof (e.g. NPV minus commissions/fees). The service may be contingent on a successful credit authorization for the amount in question, with a primary credit provider of the indebted party. Upon a successful credit authorization for the amount in question, with one or more primary credit providers of the indebted party, the secondary credit provider may forward/advance the amount of the transaction and/or NPV to the merchant/other-party, minus any fees/commissions. According to some embodiments of the present invention, a repeating cycle of re-securitizations may be initiated as described above, wherein each cycle may comprise: a re-securitization of the remaining balance; and a request for the current payment, based on to the terms pre-agreed upon by Consumer, to be transferred to the secondary credit provider (e.g. through a credit line provided to the Consumer by a primary credit provider).

According to some embodiments of the present invention, said repeating cycle may terminate after all due payments were transferred to said secondary credit provider. In the event of a re-securitization failure, said secondary credit provider may request the primary credit provider to transfer the full remaining balance from the Consumer to it, based on the last prior credit securitization performed. Credit authorization may be performed prior to the previous authorization expiring, such as to eliminate any period of time the funds are not securitized. As stated above in general, the secondary credit provider may be comprised from two or more entities in such scenarios, wherein one or more entities supply the funds and a separate entity supplies and performs the securitizations and re-securitizations of the funds.

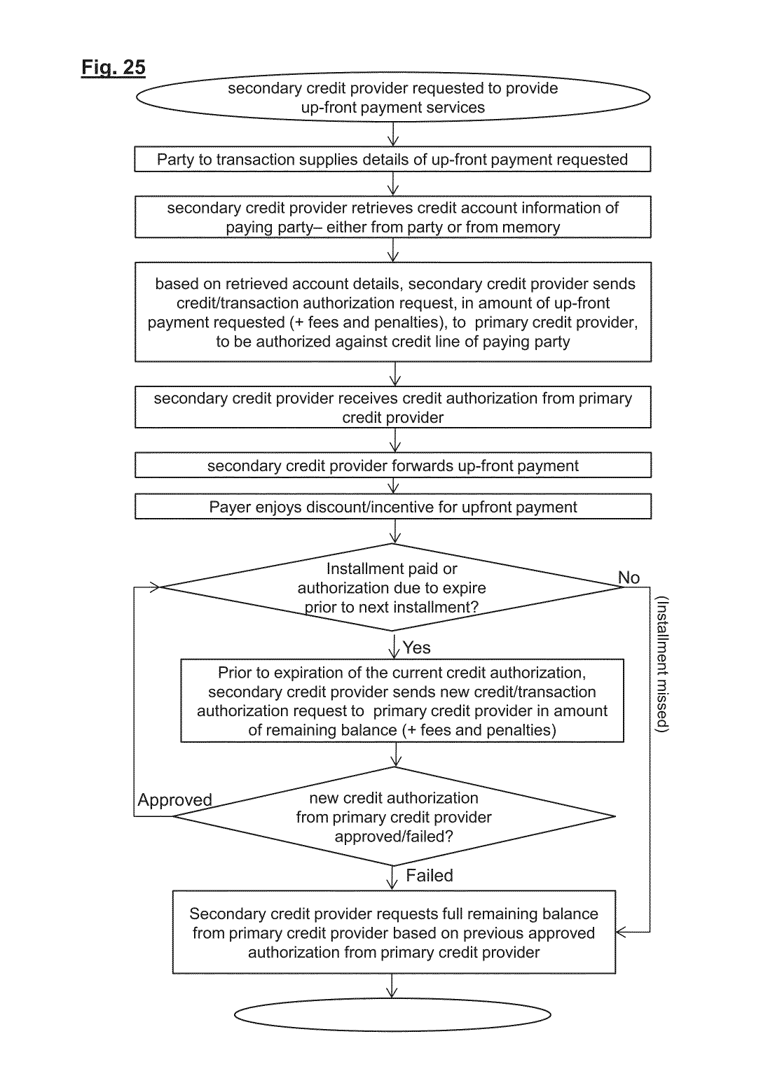

According to some embodiments, a secondary credit provider, as described herein, may use the securitization and re-securitization systems and methods described herein to offer funding of transactions that involve a discount (or other incentive) for up-front payment (e.g. utility payment, club/service memberships, licenses, software licenses, public/private transportation pass, or any other transaction which offers a discount (or other incentive) for up-front payment). The consumer/party of a particular transaction involving a discount (or other incentive) for up-front payment, that cannot afford, or doesn't wish to, provide the up-front payment, yet still wants to enjoy the discount (or other incentive) for paying the charge up-front, may obtain funding for the up-front payment from a secondary credit provider, in exchange for a fee or portion of the discount. (equally, a vendor/supplier of a service, or an authority (in the case of a utility payment for example), desiring to receive payments up-front, may use the services or methods of a secondary credit provider, as described herein, to receive up-front payment while the payers pay in installments). The secondary credit provider, upon successful securitization of the amount of the payment against a credit line of the consumer/payer with a primary credit provider, may fund the upfront payment and receive repayment of the amount from the consumer/payer in installments, while maintaining throughout a securitization of any remaining balance against credit lines of the consumer/payer with primary credit providers. An exemplary process of providing an “up-front payment funding”, in accordance with some embodiments of the present invention, is presented in the flowchart marked FIG. 25. As can be seen in the flowchart, a secondary credit provider may fund an up-front payment of a transaction involving a discount (or other incentive) for up-front payment. The service may be contingent on a successful credit authorization for the amount in question, with one or more primary credit providers of the paying party. Upon a successful credit authorization for the amount in question, with one or more primary credit providers of the paying party, the secondary credit provider may forward/advance the up-front payment, minus any fees/commissions due from the payee. According to some embodiments of the present invention, a repeating cycle of re-securitizations may be initiated as described above, wherein each cycle may comprise: a re-securitization of the remaining balance; and a request for the current payment, based on to the terms pre-agreed upon by the payer, to be transferred to the secondary credit provider (e.g. through a credit line provided to the Consumer by a primary credit provider).

According to some embodiments of the present invention, said repeating cycle may terminate after all due payments were transferred to said secondary credit provider. In the event of a re-securitization failure, said secondary credit provider may request the primary credit provider to transfer the full remaining balance from the Consumer/payer to it, based on the last prior credit securitization performed. Credit authorization may be performed prior to the previous authorization expiring, such as to eliminate any period of time the funds are not securitized. As stated above in general, the secondary credit provider may be comprised from two or more entities in such scenarios, wherein one or more entities supply the funds and a separate entity supplies and performs the securitizations and re-securitizations of the funds.

For example, some local authorities offer a discount to residents that choose to pay one or more of their utilities up-front for a full year. In such a municipality, a secondary credit provider may supply up-front payment services to residents. Thus, a resident that desires to enjoy the discount for up-front payment, while still paying the relevant charges in installments, may use the services of the secondary credit provider. The secondary credit provider may fund the upfront payment, while securitizing it against one or more credit lines provided to the resident by one or more primary credit providers. The resident may then repay the secondary credit provider in installments, while the secondary credit provider continuously re-securitizes any remaining balance against the one or more credit lines provided to the resident by the one or more primary credit providers. Of course, in the event of any re-securitization failure, the secondary credit provider may request the one or more primary credit providers to transfer the full remaining balance from the resident to it, based on the most recent credit securitization performed.

Another example may be a periodic transportation pass (e.g. metrocard, yearly train pass, etc.). Often times, public and private transportation providers offer a discount to passengers that choose to purchase multiple passages and/or a periodic pass (e.g. yearly pass, monthly pass, etc.). In such cases, it is often desirable to pay for the multiple passages and/or a periodic pass up-front. In such cases, a secondary credit provider may supply up-front payment services to passengers. Thus, a passenger that desires to enjoy the discount for up-front payment, while still paying the relevant charges in installments, may use the services of the secondary credit provider. The secondary credit provider may fund the upfront payment, while securitizing it against one or more credit lines provided to the passenger by one or more primary credit providers. The passenger may then repay the secondary credit provider in installments, while the secondary credit provider continuously re-securitizes any remaining balance against the one or more credit lines provided to the passenger by the one or more primary credit providers. Of course, in the event of any re-securitization failure, the secondary credit provider may request the one or more primary credit providers to transfer the full remaining balance from the passenger to it, based on the most recent credit securitization performed.

In such examples, the up-front payment services may be offered directly to the resident/passenger by the secondary credit provider. Alternatively (or in conjunction) the up-front payment services may be arranged by the municipality or public works company/office (in the case of utilities) or the transportation authority/company (in the case of transportation passes), possibly using the services of the secondary credit provider behind the scenes or linking the resident/passenger to the secondary credit provider.

In another example, a similar system and process may be used to pay a yearly country club membership which includes a discount for up-front payment, or a tuition for a scholarly institute which also offers a discount for up-front payment.

According to some embodiments, a secondary credit provider may offer the up-front payment service to payers/consumers who may then obtain the secondary service provider's services in order to enjoy the relevant discounts/incentives. According to further embodiments, a secondary credit provider may offer the up-front payment services to the payees of the relevant payments, such that these parties can offer the installment services to their payers and thus receive more payments up-front. E.g. a country club may offer its members the services of a secondary credit provider in order to pay in installments while still enjoying the up-front discount offered by the country club.

In another example, a secondary credit provider may settle a deal with a municipality, such that any resident going online to pay his/her utilities will see a control element configured to arrange for up-front payment of his/her utility, by funding of a secondary credit provider, against a credit line of the resident with a primary credit provider.

It should be understood that, as the systems and methods described herein create a situation in which a supplier of funds (secondary credit provider) faces little to no risk of losing his/her funds (due to the securitization and re-securitization of the funds with a primary credit provider), this supplier can afford to offer very competitive fees and interest rates on the funding services supplied.

Further, according to some embodiments, the system, described herein, may be organized and structured to perform other tasks beyond the tasks for the methods described in this invention.

According to some embodiments, the system, described herein, is organized and structured to accommodate affiliation program(s) for the individuals and/or entities, who are able to organize relation of owner and/or operator of such system, on the one hand, and merchant(s) and/or consumer(s), and/or acquirers(s), and/or secondary credit provider(s), and/or any other party, on the other hand.

Further, such a system may be designed to provide individualized relevant information (e.g. report(s)), on a need to know basis, to each member of the affiliation program. Also such a system may have modules for the analysis of provided information. Such provided information may be given upon request and/or intermittently. Further a member of the affiliation program may be provided with automatic signals/notifications (e.g. SMS, e-mail) that there are predetermined changes of relevant variables, factors and so on, and/or occurrences of certain predefined events.

The affiliation may have members of different levels. this means that members of the affiliation program may have agreements with the owner and/or operator of such a system (level 1). The member at level 1 may have agreements with other individual(s) and/or entities (level 2). The member at level 2 may have agreements with different individual(s) and/or entities (level 3).

The number of levels which could be accommodated by such a system is virtually unlimited.

The compensation provided to any particular member of the affiliation program is individualized and may vary for the different circumstances, events, cases, factors, and could be calculated using various algorithms.

In some embodiments, the system described herein may be organized to accommodate and organize promotional lotteries, bonuses, awards, prizes based on various algorithms and factors. Such lotteries, bonuses, awards, prizes could be organized separately and/or jointly for the benefits of the groups belonging to the following classes, and/or entire classes as follows:
Consumers
Merchants and/or their employees;
Member of affiliation programs, and/or their employees, and/or connection to their individuals and entities;
Primary creditors and/or their employees;
Secondary creditors and/or their employees;
Other classes of individuals and/or entities

According to some embodiments, the system described herein, may be capable of accommodating and organizing various jackpots, including but not limited to: progressive jackpots, random event jackpots and so on; such jackpots may be based on various algorithms and factors. Such jackpots could be organized separately and/or jointly, and/or partially jointly for the benefit of the groups belonging to the following classes, and/or entire classes as follows:
Consumers;
Merchants and/or their employees;
Members of affiliation programs, and/or their employees, and/or connected to them individuals and entities;
Primary credit providers and/or their employees;
Secondary credit provider and/or their employees;
Other classes of individuals and/or entities

### Exemplary Embodiments

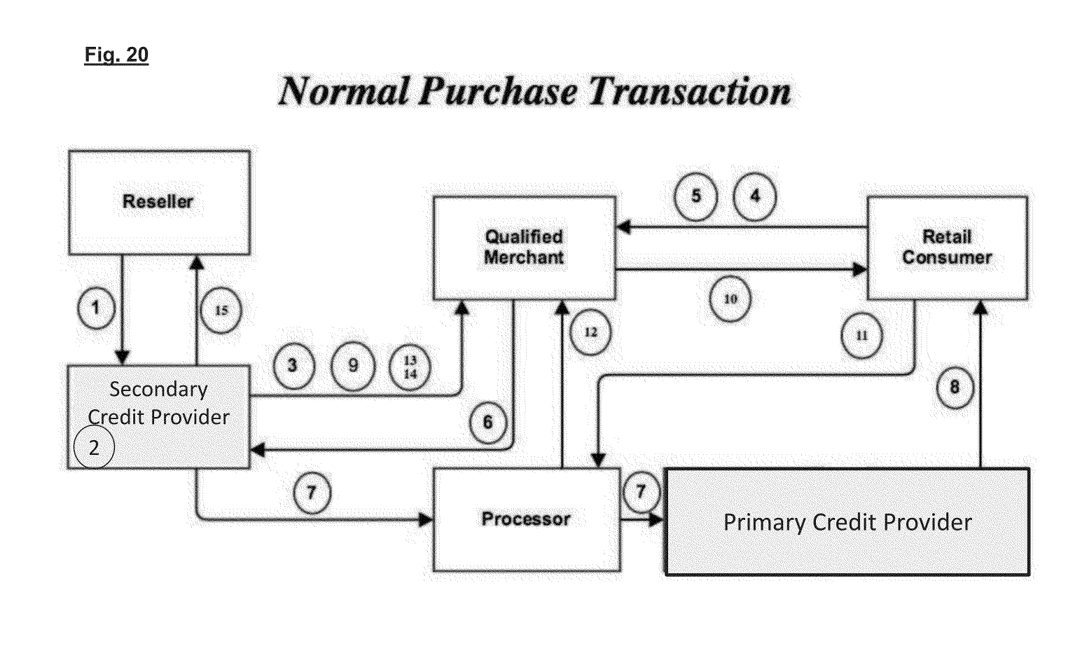

In order to help demonstrate the implementation of the systems and methods described herein, FIGS. 20-24 present exemplary commercial implementations of some embodiments of the present invention, wherein: FIGS. 20-24 present exemplary business models based upon the principles of the present invention:

FIG. 20 presents an exemplary Normal Purchase Transaction scenario in the context of the present invention. The numbering within the figure represents:
1. The reseller signs up the merchant and sends the merchant application to secondary credit provider;
2. The merchant goes through an underwriting process in order to be approved as a “secondary credit provider” Merchant member
3. Secondary credit provider approves/declines the merchant's request to be a secondary credit provider member
4. A consumer wants to buy goods at a retail store and wants to pay in monthly installments
5. The consumer approves the consumer disclaimer
6. The merchant sends the transaction to secondary credit provider
7. Secondary credit provider submits the transaction through the processor to the Primary Credit Provider
8. The Primary Credit Provider approves the transaction (Full authorized amount)
9. Secondary credit provider approves consumer's installment transaction
10. The merchant delivers the goods to the consumer
11. The consumer will pay for his purchase in monthly installments
12. The processor will assign the payment to the merchant's bank account, and the consumer's outstanding balance will be lowered with each payment until the last payment was paid
13. Secondary credit provider will issue a statement for the whole set of fees to the merchant, for the previous months' fees and will send it to him until the 4th of each month
14. Secondary credit provider will debit the merchant's account via ACH for the previous months fees on the 5th of each month
15. On the 20th of each month secondary credit provider finance will credit the reseller account for the previous month's related fees through an ACH system.

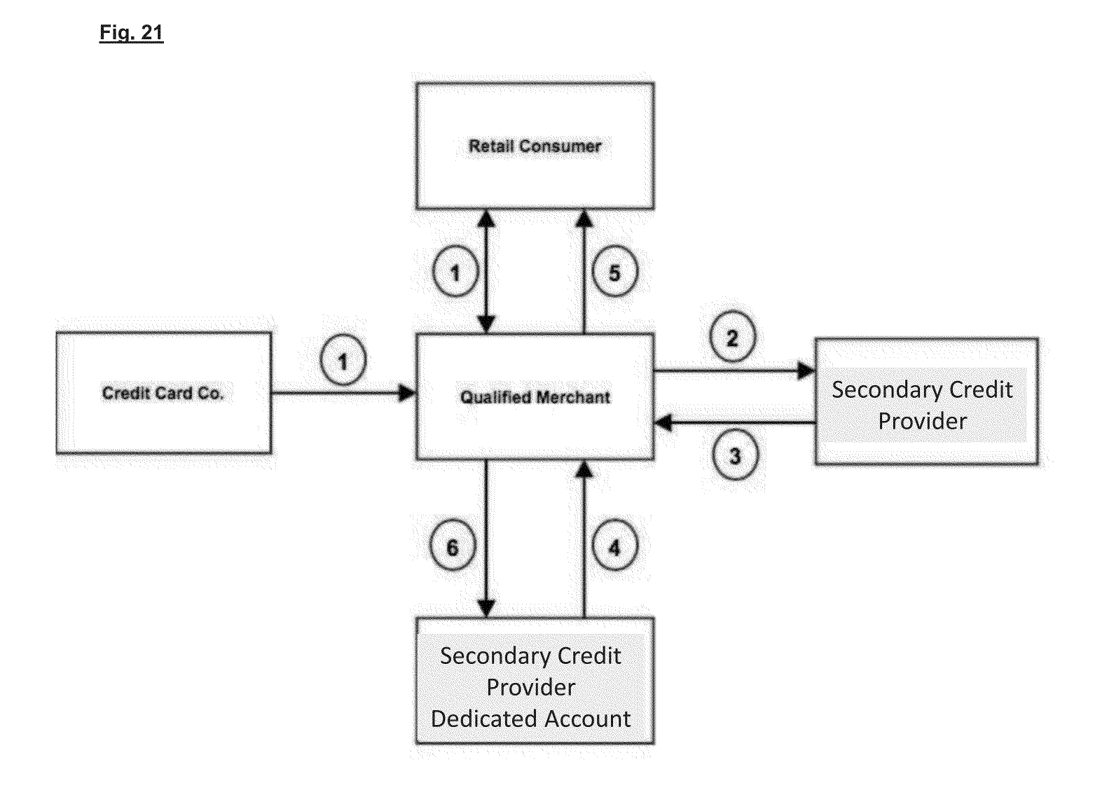

FIG. 21 presents an exemplary Refund/Chargeback Transaction—SCP—scenario in the context of the present invention. The numbering within the figure represents:
1. In certain circumstances, the consumer may have the right to return the purchased goods and get their money back. The claim may be from a Refund (driven by agreed upon terms between the Merchant and the Consumer at the time of purchase i.e., money back guarantee), or the claim may be from a Chargeback (driven by the Credit Card network rules regarding the rights for a consumer within a given time frame) to claim that the goods purchased were not as claimed by the Merchant. In case of a Chargeback, the Credit Card network will inform the Merchant that a consumer has initiated a Chargeback. If the Chargeback or Refund is approved, then the Merchant will need to refund any installment payments made-to-date.
2. The Merchant will inform the secondary credit provider to cancel the remaining unprocessed installments regarding the Refund/Chargeback transaction
3. Secondary credit provider will process the refund/chargeback through secondary credit provider system and will cancel the rest of the specific installment plan from the merchant's account
4. Secondary credit provider will issue an invoice for the amount of Refund/Chargeback for the specific product or service and will send it to the merchant.
5. The merchant will credit the consumer for the refund/chargeback amounts according to his refund policy
6. If a cash advance has been made on a transaction being processed under a Chargeback or Refund, the Merchant is required to return the outstanding balance of the advance to secondary credit provider within 24 hours

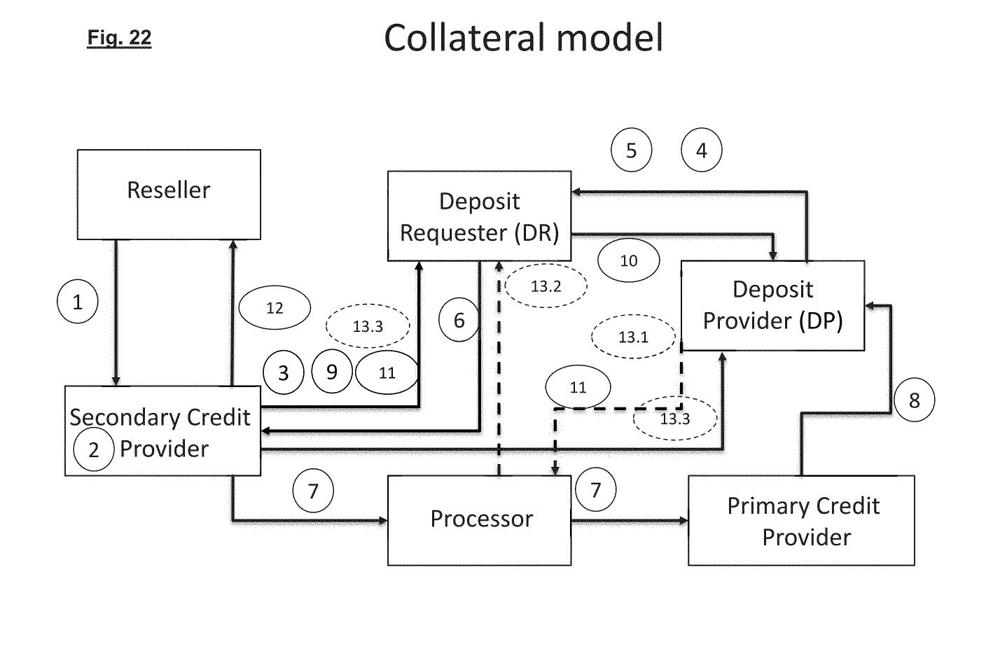

FIG. 22 presents an exemplary security deposit scenario in the context of the present invention. The numbering within the figure represents:
1. The reseller signs up the Deposit requester (DR) and sends the DR application to the secondary credit provider
2. The DR goes through an underwriting process in order to be approved as a secondary credit provider member
3. Secondary credit provider approves/declines the DR request to be a secondary credit provider member
4. A Deposit provider (DP) wants to use secondary credit provider system for his deposit
5. The DP approves the DP disclaimer
6. The DR sends the transaction to secondary credit provider
7. Secondary credit provider submits the transaction through the processor to the Primary Credit Provider
8. The Primary Credit Provider approves the transaction (Authorization on the deposit amount)
9. Secondary credit provider approves DP's deposit transaction
10. The DR provide the good or service to the DP
11. Fees might be charged to the DR or to the DP (depending on the DR decision)
12. On the 20th of each month secondary credit provider finance will credit the reseller account for the previous month's related fees through an ACH system.
13. A further example:
13.1 The DP might also pay for a monthly service associated with the DR proposition through secondary credit provider system.
13.2 The processor will assign the payment to the DR's bank account.
13.3 Fees might be charged to the DR or to the DP (depending on the DR decision)

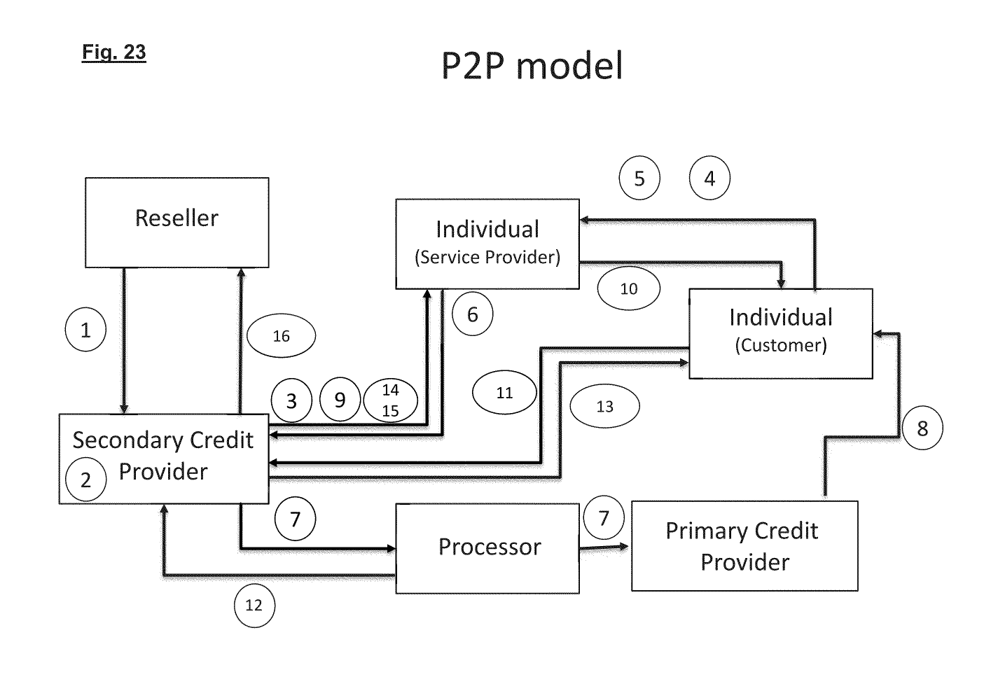

FIG. 23 presents an exemplary individual-to-individual Transaction scenario (P2P) in the context of the present invention. The numbering within the figure represents:
1. The reseller signs up the Individual—Service Provider (I-SP) and will send the I-SP application to secondary credit provider
2. The I-SP will go through an underwriting process in order to be approved as secondary credit provider member
3. Secondary credit provider approves/declines the I-SP's request to be a secondary credit provider member
4. An Individual—Customer (IC) wants to buy goods or pay for a service and wants to pay in monthly installments
5. The IC approves the consumer disclaimer
6. The I-SP sends the transaction to secondary credit provider
7. Secondary credit provider submits the transaction through the processor to the Primary Credit Provider
8. The Primary Credit Provider approves the transaction (Full authorized amount)
9. secondary credit provider approves IC's installment transaction
10. The I-SP delivers the goods/finalize the service to the IC.
11. The IC will pay for his purchase in monthly installments to Secondary Credit Provider.
12. The processor will assign the payment to secondary credit provider's bank account, and the IC's outstanding balance will be lowered with each payment until the last payment was paid
13. Secondary credit provider will transfer the payment received to the I-SP account.
14. Secondary credit provider will issue a statement for the whole set of fees to the I-SP, for the previous months' fees and will send it to him until the 4th of each month
15. Secondary credit provider will debit the I-SP's account via ACH for the previous months fees on the 5th of each month
16. On the 20th of each month secondary credit provider finance will credit the reseller account for the previous month's related fees through an ACH system.

FIG. 24 presents an illustration of a secondary credit provider providing installment/security services to different parties through different venues. When adding the collateral model, P2P model, retail merchant model, merchant advance (NPV) model, there may be created a general installment service providing installment and deposit services for different verticals and persons, B2B, B2C, C2C. The service might be called an Installment/Security HUB.

It should be understood that the exemplary embodiments presented in FIGS. 20-24 are intended for demonstrative purposes and should not be construed to encompass the full scope of the present invention in any way.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method for providing financing, said method comprising:
using communication circuitry to receive, over a data network, data indicating a cost associated with a transaction;
using the communication circuitry to receive, over the data network: (a) identifying details of a first party to the transaction, and (b) details of a credit line the first party has with a primary credit provider;
securitizing, over the data network, at least part of the cost against the credit line, by sending to the primary credit provider, using the communication circuitry, a request for a credit authorization for the at least part of the cost and receiving a first credit authorization, from the primary credit provider, for the at least part of the cost;
financing at least part of the cost upon said securitization;
and
prior to expiration of the first credit authorization, automatically re-securitizing an outstanding balance of the at least part of the cost against the credit line, by sending to the primary credit provider, using the communication circuitry, a second request for a credit authorization for the outstanding balance of the at least part of the cost and receiving a second credit authorization from the primary credit provider for the outstanding balance of the at least part of the cost.

2. The method according to claim 1, wherein the cost is a cost of a security, collateral, deposit or bond requested or required from the first party by a third party.

3. The method according to claim 2, wherein a partial payment is received from the primary credit provider between said securitization and said re-securitization and the outstanding balance of the at least part of the cost includes the at least part of the cost minus an amount of the partial payment.

4. The method according to claim 2, wherein a partial payment is received from the first party between said securitization and said re-securitization and the outstanding balance of the at least part of the cost includes the at least part of the cost minus an amount of the partial payment.

5. The method according to claim 2, further comprising receiving full balance payment from the primary credit provider upon a re-securitization failure.

6. The method according to claim 2, further comprising continuously re-securitizing outstanding balances of the at least part of the cost against the credit line provided by the primary credit provider to the first party, by, prior to each credit authorization expiring, sending, using the communication circuitry, a new request to the primary credit provider for a credit authorization for a current outstanding balance of the at least part of the cost and receiving a new credit authorization from the primary credit provider for the current outstanding balance of the at least part of the cost, until the outstanding balance equals zero or the security, collateral, deposit or bond is returned or cancelled.

7. The method according to claim 2, further comprising continuously re-securitizing the at least part of the cost against the credit line provided by the primary credit provider to the first party, by, prior to each credit authorization expiring, sending, using the communication circuitry, a new request to the primary credit provider for a credit authorization for the at least part of the cost and receiving a new credit authorization from the primary credit provider for the at least part of the cost, until the security, collateral, deposit or bond is returned or cancelled.

8. A system for providing financing, said system comprising:
a transaction server including communication circuitry and control logic adapted to collectively finance costs of other parties; and
one or more financing servers comprising:
one or more application programming interfaces (APIs) for interfacing with one or more servers of primary credit providers;
and
processing circuitry including collective control logic adapted to: (1) receive, over a data network, data indicating a cost associated with a transaction; (2) receive, over the data network: (a) identifying details of a first party to the transaction, which first party is obligated to the cost and (b) details of a credit line the first party has with a primary credit provider; (3) securitize, using said APIs, at least part of the cost against the credit line provided by the primary credit provider to the first party, by sending to the primary credit provider a request for a credit authorization for the at least part of the cost and receiving a first credit authorization from the primary credit provider for the at least part of the cost; (4) cause said transaction server to finance at least part of the cost upon securitization; and (5) prior to expiration of the first credit authorization, using said APIs to re-securitize an outstanding balance of the at least part of the cost against the credit line provided by the primary credit provider to the first party, by sending to the primary credit provider a second request for a credit authorization for the outstanding balance of the at least part of the cost and receiving a second credit authorization from the primary credit provider for the outstanding balance of the at least part of the cost.

9. The system according to claim 8, wherein the cost associated with a transaction is a cost of a security, collateral, deposit or bond requested or required from the first party by a third party.

10. The system according to claim 9, wherein said transaction server is further adapted to receive a partial payment from the primary credit provider between the securitization and the re-securitization and the outstanding balance of the at least part of the cost includes the at least part of the cost minus an amount of the partial payment.

11. The system according to claim 9, wherein said transaction server is further adapted to receive a partial payment from the primary credit provider between the securitization and the re-securitization and the outstanding balance of the at least part of the cost includes the at least part of the cost minus an amount of the partial payment.

12. The system according to claim 9, wherein said financing server is further adapted to request, using said APIs, full balance payment from the primary credit provider upon a re-securitization failure.

13. The system according to claim 9, wherein said financing servers are further adapted to continuously re-securitize outstanding balances of the at least part of the cost against the credit line provided by the primary credit provider to the first party, by, prior to each credit authorization expiring, sending a new request to the primary credit provider for a credit authorization for a current outstanding balance of the at least part of the cost and receiving a new credit authorization from the primary credit provider for the current outstanding balance of the at least part of the cost, until the outstanding balance equals zero or the security, collateral, deposit or bond is returned or cancelled.

14. The system according to claim 9, wherein said financing servers are further adapted to continuously re-securitize the at least part of the cost against the credit line provided by the primary credit provider to the first party, by, prior to each credit authorization expiring, sending a new request to the primary credit provider for a credit authorization for the at least part of the cost and receiving a new credit authorization from the primary credit provider for the at least part of the cost, until the security, collateral, deposit or bond is returned or cancelled.

15. A method for providing a security, said method comprising:
using communication circuitry to receive, over a data network, data indicating a cost of a security, collateral, deposit or bond requested or required from a first party, which security, collateral, deposit or bond the first party wishes to have financed by another party;
using the communication circuitry to receive, over the data network: (1) identifying details of the first party, and (2) an identity of one or more primary credit providers with which the first party has credit lines;
securitizing, over the data network, the cost, against the credit lines provided by the one or more primary credit providers to the first party, by sending to the one or more primary credit providers, using the communication circuitry, requests for credit authorizations totaling the cost and receiving a first set of credit authorizations from the one or more primary credit providers totaling the cost;
financing the security, collateral, deposit or bond upon securitization; and
prior to expiration of the first set of credit authorizations, automatically re-securitizing an outstanding balance of the cost against the credit lines provided by the one or more primary credit providers to the first party, by sending to the one or more primary credit providers, using the communication circuitry, second requests for credit authorizations totaling the outstanding balance of the cost and receiving a second set of credit authorizations from the one or more primary credit providers for the outstanding balance of the cost.

16. The method according to claim 15, wherein a partial payment is received from the primary credit provider between said securitization and said re-securitization and the outstanding balance of the cost includes the cost minus the partial payment sum.

17. The method according to claim 15, wherein a partial payment is received from the first party between said securitization and said re-securitization and the outstanding balance of the cost includes the cost minus the partial payment sum.

18. The method according to claim 15, further comprising receiving full balance payment from the one or more primary credit providers upon a re-securitization failure.

19. The method according to claim 15, further comprising continuously re-securitizing outstanding balances of the cost against the credit lines provided by the one or more primary credit providers to the first party, by, prior to each set of credit authorizations expiring, sending, using the communication circuitry, new requests to the one or more primary credit providers for credit authorizations totaling a current outstanding balance of the cost and receiving a new set of credit authorizations from the one or more primary credit providers totaling the current outstanding balance of the cost, until the outstanding balance equals zero or the security, collateral, deposit or bond is returned or cancelled.

20. The method according to claim 2, further comprising continuously re-securitizing the cost against the credit lines provided by the one or more primary credit providers to the first party, by, prior to each set of credit authorizations expiring, sending, using the communication circuitry, new requests to the one or more primary credit providers for credit authorizations totaling the cost and receiving a new set of credit authorizations from the one or more primary credit providers totaling the cost, until the security, collateral, deposit or bond is returned or cancelled.
